(19) United States
(12) Patent Application Publication
(10) Pub. No.: US 2026/0230720 A1
(43) Pub. Date: Aug. 6, 2026

(54) INSPECTION SYSTEM, INFORMATION PROCESSING DEVICE, INSPECTION METHOD, AND PROGRAM

(71) Applicant: Sony Semiconductor Solutions Corporation, Kanagawa (JP)

(72) Inventors: Tatsuya Higashisaka, Kanagawa (JP); Satoshi Ihara, Tokyo (JP); Takehiro Aoshima, Kanagawa (JP)

(21) Appl. No.: 19/147,895

(22) PCT Filed: Dec. 27, 2023
(86) PCT No.: PCT/JP2023/046863

§ 371 Date: Jul. 14, 2025

(30) Foreign Application Priority Data
Feb. 15, 2023 (JP) 2023-021536

(51) Int. Cl. H04N 25/47; G01N 21/892; H04N 23/56; H04N 25/707

(52) U.S. Cl. CPC H04N 25/47; G01N 21/892; H04N 23/56; H04N 25/707

(57) ABSTRACT

This inspection system includes: an event-based vision sensor that captures an image of an inspection object and detects changes in luminance for each pixel as an event; and a control unit that performs determination of defect presence in the inspection object on the basis of event data that is output from the event-based vision sensor according to the detected event.

### TECHNICAL FIELD

The present technology relates to a technology of an inspection system, an information processing device, an inspection method, and a program using an event-driven image sensor.

### BACKGROUND ART

A device that detects a defect in an inspection object on the basis of captured images of the inspection object is known.

For example, the following Patent Document 1 discloses a technology for detecting a surface defect on magnetic tape using a charge coupled device (CCD) image sensor.

### CITATION LIST

### Patent Document

Patent Document 1: Japanese Patent Application Laid-Open No. 2008-140504

### SUMMARY OF THE INVENTION

### Problems to Be Solved by the Invention

In such a configuration, the inspection time varies in a manner that depends on the extraction speed of the magnetic tape. Then, the extraction speed of the magnetic tape is constrained by the exposure time of the CCD image sensor. Furthermore, the extraction of luminance information also takes time, making it difficult to reduce the inspection time.

The present technology has been made in view of such circumstances, and it is therefore an object of the present technology to reduce the time required to inspect an inspection object using an image sensor.

### Solutions to Problems

An inspection system according to the present technology includes: an event-based vision sensor that captures an image of an inspection object and detects changes in luminance for each pixel as an event; and a control unit that performs determination of defect presence in the inspection object on the basis of event data that is output from the event-based vision sensor according to the event that has been detected.

Only pixels exhibiting changes in luminance output the event data, enabling the event-based vision sensor to capture the appearance of a subject quickly and with low latency, compared to frame-based image sensors.

An information processing device according to the present technology includes a control unit that performs determination of defect presence in an inspection object on the basis of event data output from an event-based vision sensor that captures an image of the inspection object and detects changes in luminance for each pixel as an event.

An inspection method according to the present technology includes performing, by a computation device, determination of defect presence in an inspection object on the basis of event data output from an event-based vision sensor that captures an image of the inspection object and detects changes in luminance for each pixel as an event.

A program according to the present technology causes an information processing device to implement performing determination of defect presence in an inspection object on the basis of event data output from an event-based vision sensor that captures an image of the inspection object and detects changes in luminance for each pixel as an event.

### BRIEF DESCRIPTION OF DRAWINGS

FIG. 1 is a diagram schematically illustrating a scene of an inspection using an inspection system according to a first embodiment.

FIG. 2 is a block diagram illustrating an example configuration of an event-based vision sensor.

FIG. 3 is a block diagram illustrating an example configuration of the inspection system.

FIG. 4 is a diagram schematically illustrating how an inspection object is moved by a winding device that is an example of a conveying device.

FIG. 5 is a diagram schematically illustrating an example where a camera device is positioned to ensure that the orientation of an EVS corresponds to the characteristics of a defect.

FIG. 6 is a diagram schematically illustrating another example where the camera device is positioned to ensure that the orientation of the EVS corresponds to the characteristics of a defect.

FIG. 7 is a block diagram illustrating an example of a signal processing unit when using a second defect. detection method.

FIG. 8 is a flowchart illustrating an example of processing that is performed by the inspection system.

FIG. 9 is a flowchart illustrating an example of processing that is performed by the inspection system for parameter adjustment.

FIG. 10 is a block diagram illustrating an example configuration of the signal processing unit when using the second defect detection method.

FIG. 11 is a diagram schematically illustrating a scene of an inspection using an inspection system according to a modification of the first embodiment.

FIG. 12 is a diagram schematically illustrating a scene of an inspection using an inspection system according to a second embodiment.

FIG. 13 is a block diagram illustrating an example configuration of the inspection system according to the second embodiment.

FIG. 14 is a block diagram illustrating an example configuration of an inspection system according to a third embodiment.

FIG. 15 is a flowchart illustrating an example of processing that is performed by the inspection system according to the third embodiment.

FIG. 16 is a diagram schematically illustrating a scene of an inspection using an inspection system according to a fourth embodiment, showing an example of a case where a flat portion is irradiated with irradiation light.

FIG. 17 is a diagram schematically illustrating a Scene of an inspection using the inspection system according to the fourth embodiment, showing an example of a case where a defect portion is irradiated with irradiation light.

FIG. 18 is a block diagram illustrating an example configuration of the inspection system according to the fourth embodiment.

FIG. 19 is a block diagram illustrating an example configuration of an inspection system according to a fifth embodiment.

FIG. 20 is a diagram schematically illustrating a first arrangement example of inspection units according to the fifth embodiment.

FIG. 21 is a diagram schematically illustrating a second arrangement example of the inspection units according to the fifth embodiment.

FIG. 22 is a diagram schematically illustrating a third arrangement example of the inspection units according to the fifth embodiment.

FIG. 23 is a diagram schematically illustrating a modification of the third arrangement example of the inspection units according to the fifth embodiment.

FIG. 24 is a block diagram illustrating an example configuration of a signal processing unit according to the modification.

FIG. 25 is a diagram schematically illustrating a scene of an inspection based on dark-field imaging using an inspection system according to the modification.

FIG. 26 is a diagram schematically illustrating a scene of inspection based on bright-field imaging using an inspection system according to the modification.

### MODE FOR CARRYING OUT THE INVENTION

Hereinafter, embodiments according to the present technology will be described in the following order with reference to the accompanying drawings.
<1. Configuration of inspection system>
<2. Defect detection method>
<2-1. First detection method>
<2-2. Second detection method>
<3. Modifications of first embodiment>
<4. Second embodiment>
<5. Third embodiment>
<6. Fourth embodiment>
<7. Fifth embodiment>
<8. Modifications>
<9. Conclusion>
<10. Present technology>

### 1. Configuration of Inspection System

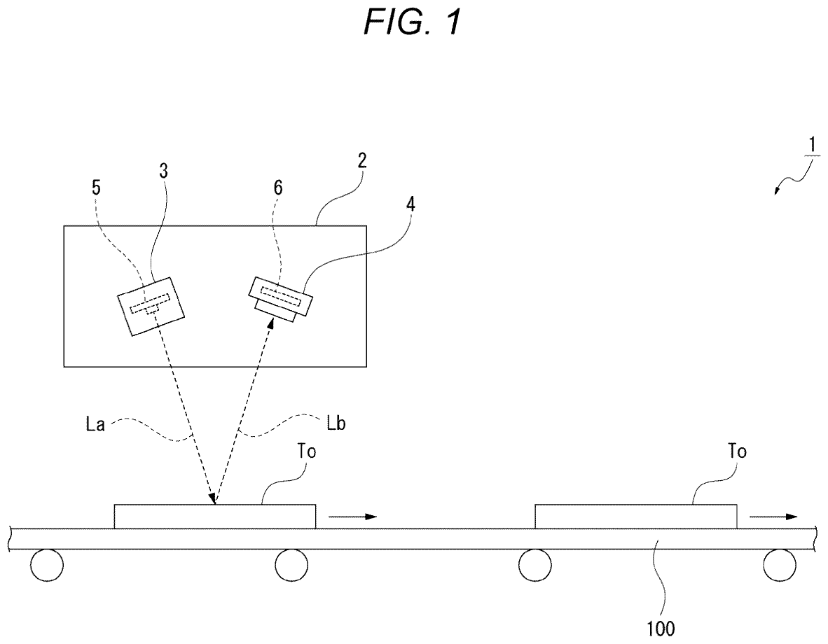

FIG. 1 illustrates a diagram schematically illustrating how to inspect an inspection object To using an inspection system 1 of the present technology.

As illustrated in FIG. 1, the inspection system 1 serves as a system that inspects the inspection objects To conveyed in a fixed direction by a conveying device 100 such as a belt conveyor.

Note that the conveying device 100 such as a belt conveyor may constitute a part of the inspection system 1.

The inspection object To has an approximately flat surface. The inspection system 1 can detect an irregular uneven shape formed on the approximately flat surface of the inspection object To as a defect.

To enable the capability, the inspection system 1 includes an inspection unit 2.

The inspection unit 2 includes a lighting device 3 and a camera device 4.

The lighting device 3 includes a light source 5. Light emitted from the light source 5 enters the camera device 4.

In the following description, imaging performed by the camera device 4 in a positional relationship where the light emitted from the light source 5 is reflected off the inspection object To to enter the camera device 4 is referred to as “bright-field imaging”. Note that the term “imaging” as used herein does not refer to outputting a frame-based captured image, but refers to receiving incident light over a predetermined period of time and outputting some signal on the basis of the result.

In the bright-field imaging, in a case where the light emitted from the light source 5 is reflected off a flat portion having no defect, the flat portion is imaged as a bright portion. Then, in a case where the light emitted from the light source 5 is irregularly reflected off an uneven portion serving as a defect, the portion having the defect is imaged as a dark portion.

Furthermore, the light emitted from the light source 5 is referred to as “irradiation light La”, and the light generated when the irradiation light La is reflected off the inspection object To is referred to as “reflected light Lb”.

The camera device 4 includes an image sensor capable of detecting such changes in luminance. Specifically, the camera device 4 includes an event-based vision sensor 6 serving as an image sensor. In the following description, the event-based vision sensor 6 is referred to as “EVS 6”.

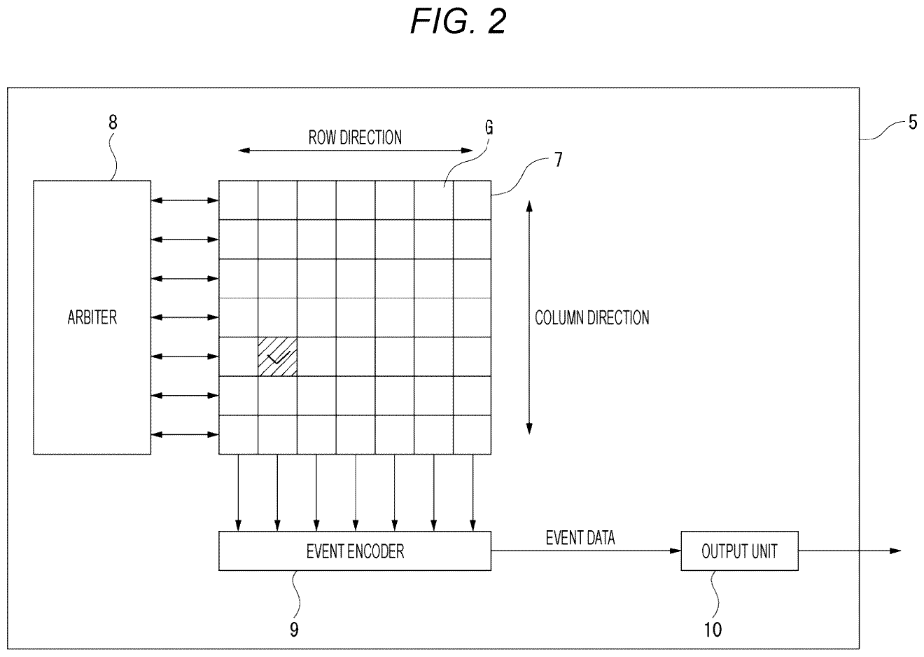

As illustrated in FIG. 2, the EVS 6 includes, for example, a pixel array unit 7, an arbiter 8, an event encoder 9, and an output unit 10.

The pixel array unit 7 includes pixels G arranged in a two-dimensional grid pattern. In the example illustrated in FIG. 2, a direction in which a plurality of pixels G is arranged horizontally is defined as a row direction (horizontal direction), and a direction in which a plurality of pixels G are arranged vertically is defined as a column direction (vertical direction).

Each of the pixels G includes a photoelectric conversion element (for example, a photodiode) that performs photoelectric conversion based on incident light to generate charge, and an event detection unit that detects an event on the basis of a difference between a reference level and a level of a light reception signal.

The event detection unit included in each pixel G can distinguish and detect an ON event triggered when the quantity of received light increases beyond a certain level and an OFF event triggered when the quantity of received light decreases below the certain level. To enable the capability, each pixel G includes a circuit that converts the quantity of incident light into a Log output and outputs the Log output, a circuit that outputs a difference from the previous signal, a circuit that differentiates and outputs whether the detected event is the ON event or the OFF event, and the like.

The arbiter 8 arbitrates conflicts among requests from the pixels G in the pixel array unit 7 and causes the pixel G selected on the basis of the arbitration result to output an event signal to the event encoder 9.

Note that the arbiter 8 may be capable of causing a plurality of pixels G where the event is detected among the plurality of pixels G arranged in the row direction to output the event signals approximately simultaneously. In the following description, a direction in which a plurality of pixels G that can be read simultaneously is arranged is referred to as a “readout direction”. That is, in a case where the event signals are output from the plurality of pixels G arranged in the row direction in response to a single readout command, the readout direction corresponds to the “row direction”. Furthermore, line-by-line readout for the rows or columns is referred to as “unit readout”.

As described above, the event signal is output from the pixel G (hatched pixel G in FIG. 2) where the event is detected to the event encoder 9.

The event encoder 9 generates event data ED on the basis of the event signal output from the pixel G.

The event data ED includes at least a type of event (whether it is the ON event or the OFF event), information for identifying the position of the pixel G where the event has occurred (x coordinate and y coordinate), and time stamp information for identifying the occurrence time of the event.

The event data ED generated by the event encoder 9 is provided to the output unit 10.

The output unit 10 outputs the event data ED in a predetermined format.

The relative position of the lighting device 3 and the camera device 4 included in the inspection unit 2 remains unchanged. Furthermore, the distance between the inspection unit 2 and an inspection target portion of the inspection object To remains unchanged.

This configuration ensures that the quantity of the reflected light Lb in a case where no defect is present in the inspection object To, that is, the light entering the camera device 4, remains constant.

It is therefore desirable that the inspection unit 2 be integrated as a unit including the lighting device 3 and the camera device 4. However, the lighting device 3 and the camera device 4 may be arranged separately, and position control may be implemented to ensure that their relative positions remains unchanged.

Furthermore, the term “inspection unit 2” used herein is also for the sake of convenience of description, and does not necessarily require the lighting device 3 and the camera device 4 to be integrated into a single unit.

Furthermore, as the light source 5 included in the lighting device 3, it is desirable to use a flicker-free light source to ensure that the quantity of the irradiation light La from the light source 5 remains constant. The flicker-free light source 5 is, for example, a non-blinking light source 5. This configuration can ensure that the quantity of the irradiation light La from the lighting device 3 remains constant.

It is therefore possible to prevent each pixel G of the EVS 6 from detecting an unnecessary event generated by blinking of the light source 5.

Note that the EVS 6 is capable of high-speed readout compared to frame-based image sensors, as the event signal is output in synchronization with the event Occurrence timing of each pixel.

However, the present technology is not limited to the above configuration, and it is possible to apply, to the EVS 6, a configuration where the event signal is read at predetermined intervals, in a manner similar to the frame base. Even in this case, by reading only the pixel G where the event has occurred, it is possible to achieve high-speed readout compared to frame-based image sensors that read all the pixels for each frame.

In a case where the configuration where the event signal is read at predetermined intervals is applied to the EVS 6, a light source 5 that alternates between on and off states at high frequency can be used as the light source 5 included in the lighting device 3.

In this case, by synchronizing the readout timing of the EVS 6 with the turn-on/off timing, it is possible to detect, as the event, changes in the quantity of the reflected light Lb caused by a defect, regardless of changes in the turned-on state of the light source 5.

Note that, to ensure that the reflected light Lb from the inspection object To remains constant, it is desirable that the light source 5 maintain constant light wavelength, irradiation pattern, and quantity.

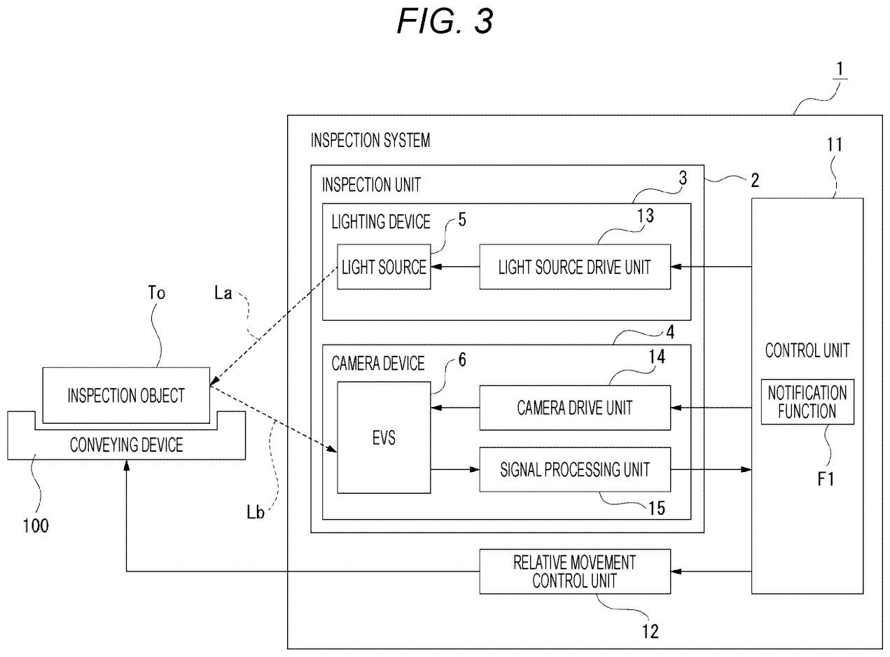

FIG. 3 illustrates an example configuration of the inspection system 1.

The inspection system 1 includes a control unit 11 and a relative movement control unit 12 in addition to the inspection unit 2 including the lighting device 3 and the camera device 4.

The lighting device 3 includes a light source drive unit 13 in addition to the light source 5.

The light source drive unit 13 performs processing to turn on and off the light source 5 in a predetermined pattern on the basis of a control signal provided from the control unit 11. The light source drive unit 13 functions as a driver that supplies a predetermined drive voltage to the light source 5.

The camera device 4 includes a camera drive unit 14 and a signal processing unit 15 in addition to the EVS 6. The camera drive unit 14 performs overall control of the camera device 4 including the EVS 6.

Specifically, the camera drive unit 14 instructs the signal processing unit 15 included in the camera device 4 to perform processing. However, the signal processing unit 15 may be configured to perform signal processing on the event signal continuously while the EVS 6 is in operation, independently of the control of the camera drive unit 14.

Furthermore, the camera drive unit 14 performs various types of drive control to ensure a good imaging condition of the EVS 6, specifically, zoom control, focus control, aperture control, and the like. Then, the camera drive unit 14 sets a threshold for appropriately detecting the event in the EVS 6, and the like.

For example, in response to a command from the camera drive unit 14, the signal processing unit 15 performs processing to generate an EVS image from the event data ED provided from the EVS 6, processing to estimate the shape, size, and the like of a defect detected in the inspection object To on the basis of a plurality of pieces of the event data ED, and the like.

The control unit 11 of the inspection system 1 transmits, to the light source drive unit 13, a command for driving the light source 5 to bring the light source 5 into light emission operation.

The control unit 11 transmits, to the camera drive unit 14 of the camera device 4, an imaging operation command to bring the camera device 4 into imaging operation. Note that the control unit 11 may directly instruct the signal processing unit 15.

The control unit 11 receives information regarding a defect in the inspection object To from the signal processing unit 15 of the camera device 4. Furthermore, the control unit 11 may acquire the event data ED via the signal processing unit 15.

The control unit 11 performs control to enable the relative movement between the inspection object To and the inspection unit 2. Specifically, in the present example, a drive command is issued to the relative movement control unit 12 to make the relative movement speed equal to a predetermined speed. Furthermore, in a case where a defect is detected in the inspection object To, the control unit 11 may instruct the relative movement control unit 12 to interrupt the relative movement.

The relative movement control unit 12 according to the present embodiment issues a drive command to the conveying device 100 that conveys the inspection object To in a predetermined direction. This causes the inspection object To placed on the conveying device 100 and the inspection unit 2 to move relatively in the horizontal direction with the vertical distance remaining constant, for example.

The control unit 11 grasps the position of the inspection object To associated with time-series data by controlling the conveying device 100 via the relative movement control unit 12. Furthermore, the control unit 11 receives information regarding defect detection timing associated with defect information from the camera device 4.

By comparing these pieces of time information, the control unit 11 can grasp the position of a defect. detected in the inspection object To.

The control unit 11 includes a notification function F1 of issuing various types of notifications. For example, the notification function F1 may issue, in a case where a defect is detected in the inspection object To, abnormality notification (alert information notification). Furthermore, the notification function F1 may issue information regarding the defect detected in the inspection object To as defect information.

A user who uses the inspection system 1 can determine whether or not to continue or interrupt the inspection of the inspection object To on the basis of these notifications.

Note that, in a case where a defect is detected, the control unit 11 may perform processing to record information regarding the defect as log information. The log information recording processing is processing that can present information regarding the defect detection to the user, and can be regarded as one aspect of the processing performed by the notification function F1.

Note that, in the example illustrated in FIG. 1, the inspection object To is placed on the conveying device 100 such as a belt conveyor and moved in one direction, but the implementation of the present technology is not limited to such a configuration.

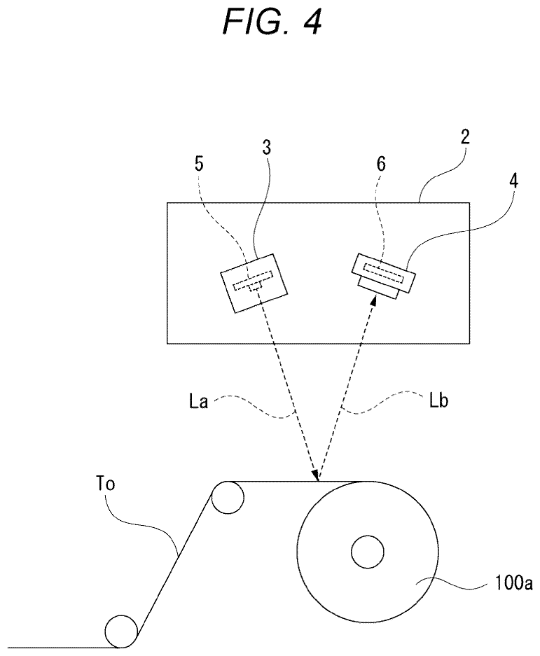

For example, as illustrated in FIG. 4, a thin-film inspection object To may be inspected while being wound onto a winding device 100a that is one form of the conveying device 100 during or after the manufacturing process of the inspection object To.

Furthermore, in the example illustrated in FIG. 4, the aspect in which the inspection object To is inspected immediately before being wound onto the winding device 100a has been given as an example; however, the present technology is not limited to such an aspect, and in a case where the curvature of the inspection object To in the wound state is sufficiently large compared to the field of view of the camera device 4, the light irradiation and event detection may be performed on the inspection object To in the wound state.

That is, if the area of the inspection object To that falls within the field of view of the camera device 4 can be considered sufficiently flat, the present technology can be applied to the defect detection of the inspection object To with a curved surface that is considered approximately flat.

Needless to say, the defect detection may be performed by applying the present technology during the process of extracting the inspection object To in the wound state.

Next, the orientation of the EVS 6 relative to the inspection object To, in other words, the orientation of the camera device 4 relative to the inspection object To, will be described.

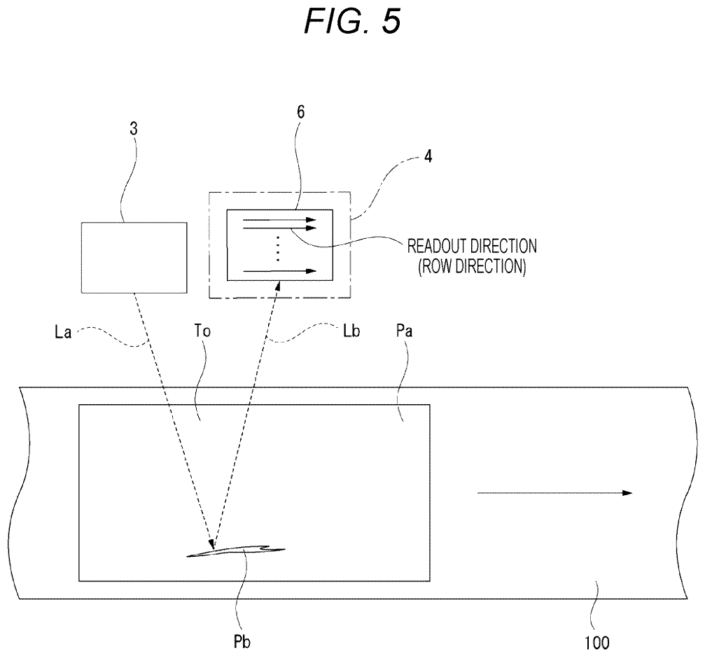

The inspection object To may exhibit distinctive defect shapes that may occur during the manufacturing process. FIG. 5 is a schematic top view of the inspection object To placed on the conveying device 100.

This inspection object To has a defect that makes the inspection object To unsuitable as a product, and the shape of the defect is elongated in the relative movement direction (conveyance direction). In the following description, an approximately flat portion without a defect of the inspection object To is referred to as a “flat portion Pa”, and a portion with a defect is referred to as a “defect portion Pb”.

It is desirable that the inspection system 1 configured to detect defects as described above determine the orientation of the EVS 6 while taking the above-described readout direction taken into consideration. In the example illustrated in FIG. 5, the readout direction is aligned with the row direction, and the EVS 6 is positioned to align the longitudinal direction of the shape of the defect portion Pb that is likely to be detected with the readout direction.

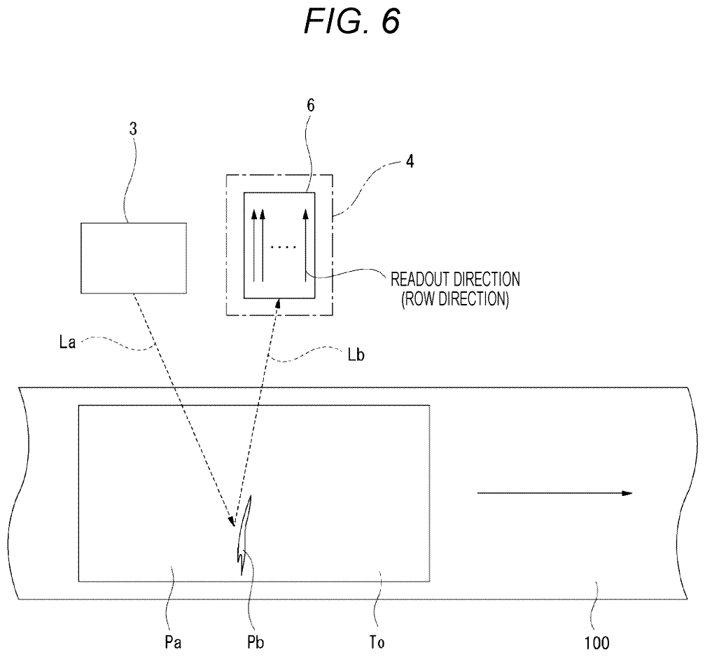

Furthermore, in the example illustrated in FIG. 6, the shape of the defect portion Pb that is likely to occur in the inspection object To has its longitudinal direction orthogonal to the relative movement direction. Therefore, the EVS 6 with the readout direction aligned with the row direction is positioned to make the readout direction orthogonal to the relative movement direction.

As described above, aligning the longitudinal direction of the defect portion Pb that is likely to occur with the readout direction of the EVS 6 concentrates a large number of pixels G where the event. occurs in a few lines, which contributes to reducing the frequency of unit readout.

Note that, in a case where the shape of the defect portion Pb that is likely to occur in the inspection object To is irregular and the longitudinal direction cannot be identified, it is desirable that the EVS 6 be positioned to align the readout direction with the relative movement direction as illustrated in FIG. 5.

This enables continuous detection of the defect in the inspection object To along the same readout row (or readout column) in the pixel array unit 7 as long as the inspection object To stays within the field of view of the EVS 6, which contributes to accelerating the readout processing.

### 2. Defect Detection Method

The defect detection processing is performed, for example, in the signal processing unit 15 of the camera device 4. Here, two types of methods will be mainly described.

### <2-1. First Detection Method>

The first detection method is a method in which the EVS image described above is not generated.

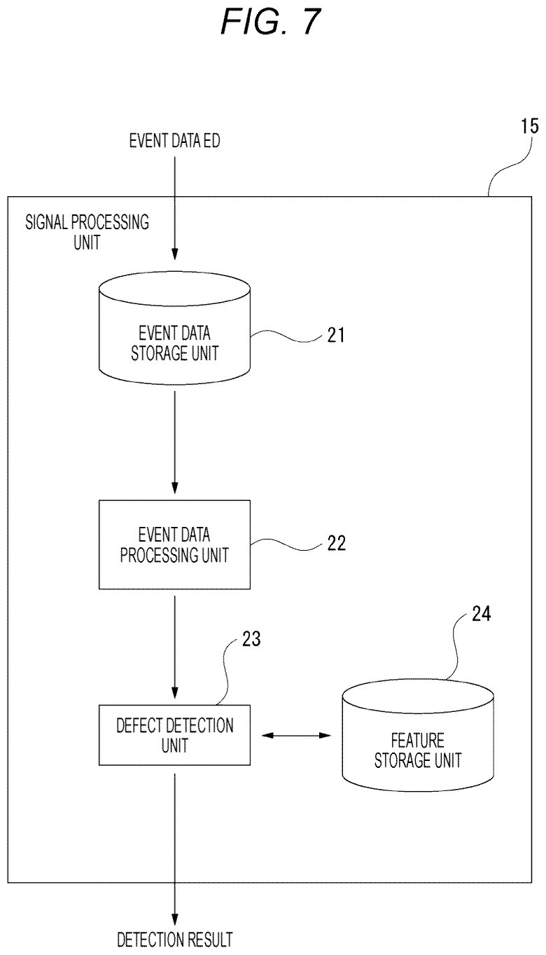

FIG. 7 illustrates a block diagram of the signal processing unit 15 of the camera device 4.

The signal processing unit 15 includes an event data storage unit 21 that stores the event data ED output from the EVS 6. The event data storage unit 21 stores, for each event data ED, pieces of information, such as an event occurrence time, an event type, and a pixel position where the event is detected, associated with each other.

The signal processing unit 15 includes an event data processing unit 22 that retrieves the event data ED from the event data storage unit 21 and performs predetermined processing.

For example, the event data processing unit 22 calculates, as the predetermined processing, the number of pieces of event data ED generated within a predetermined short period of time as an event count. A series of event data ED measured as a single event count is estimated to be a single defect detected in the inspection object To.

Note that the event count may be calculated for each predetermined area within the field of view of the EVS 6. That is, the respective event counts of pieces of event data ED detected at distant positions within the field of view of the EVS 6 may be calculated as different groups, even if detected simultaneously. In this case, a data group in which the information regarding the area where the event has occurred is associated with the event count detected in the area is output. Furthermore, pieces of event data ED detected in different areas are estimated to be separate defects.

The signal processing unit 15 includes a defect detection unit 23. The defect detection unit 23 performs processing of determination of defect presence on the basis of the data of the event count provided from the event data processing unit 22 located upstream of the defect detection unit 23. The criteria for determination of defect presence are stored in a feature storage unit 24 included in the signal processing unit 15.

For example, the defect detection unit 23 performs determination of defect presence on the basis of defect. features and event counts stored in the feature storage unit 24. For example, the feature is set as an event. count threshold, and in a case where the event count of detected event data ED is greater than the threshold, it is determined that a defect is detected.

Note that the threshold (feature) used for the comparison may be adjusted according to the size of the area where the event data ED is detected. That is, the larger the area where the event data ED is detected, the higher the threshold can be. This prevents false defect detection.

The defect detection unit 23 outputs, as the determination result, whether or not a defect is detected. It is desirable that the defect detection unit 23 outputs information indicating the position where the defect is detected in the inspection object To together with the determination result. The information indicating the position of the defect may be output as time information for identifying the timing at which the event data ED is generated. The control unit 11 located downstream can identify the position of the defect on the basis of the information regarding the time stamps.

Furthermore, the defect detection unit 23 may output not only the presence or absence and location of the detected defect but also the shape and size of the defect.

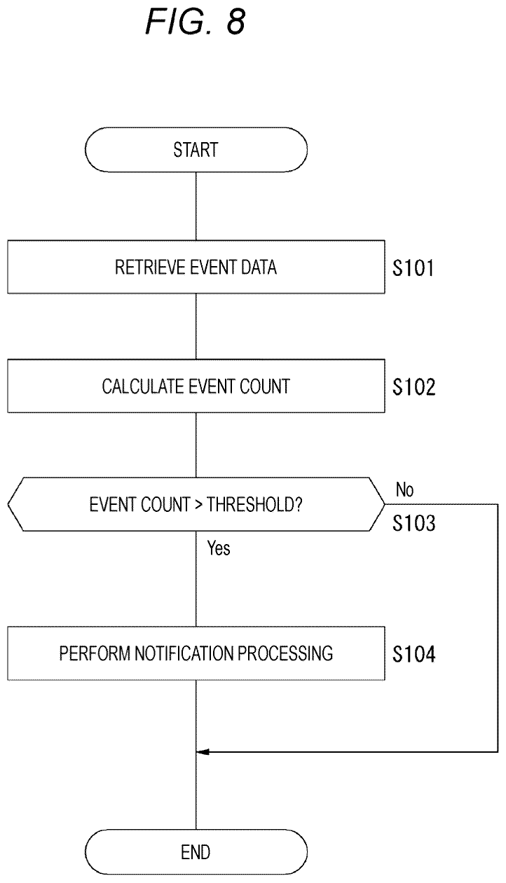

FIG. 8 illustrates an example of a flow of processing that is performed by the inspection system 1. Note that the series of processing illustrated in FIG. 8 is performed at regular time intervals.

First, in step S101, the signal processing unit 15 of the inspection system 1 retrieves the event data ED from the event data storage unit 21.

Subsequently, in step S102, the signal processing unit 15 of the inspection system 1 calculates the event count as the processing in the event data processing unit 22. Note that, as described above, in this processing, not only the event count but also the size of the area where the event data ED is detected and the like may be calculated.

In step S103, the signal processing unit 15 of the inspection system 1 performs determination of defect presence as the processing in the defect detection unit 23. The example illustrated in FIG. 8 corresponds to an example where the defect detection unit 23 determines whether or not the event count is greater than the threshold.

In a case where the event count is determined to be greater than the threshold, the control unit 11 of the inspection system 1 performs notification processing using the notification function F1. In this notification processing, as described above, the alert information indicating that a defect is detected in the inspection object To may be provided, or the information regarding the detected defect may be simply provided. Furthermore, the control unit 11 may perform processing to interrupt the relative movement between the inspection object To and the inspection unit 2 alongside the notification processing in step S104.

Furthermore, in a case where the event count is determined to be equal to or less than the threshold in step S103, the inspection system 1 terminates the series of processing illustrated in FIG. 8 and waits until the next processing timing.

Note that, in a case where the event count of event data ED detected despite no defect in the inspection object To is large, the signal processing unit 15, the camera drive unit 14, or the control unit 11 may perform processing to adjust the parameter of the inspection system 1.

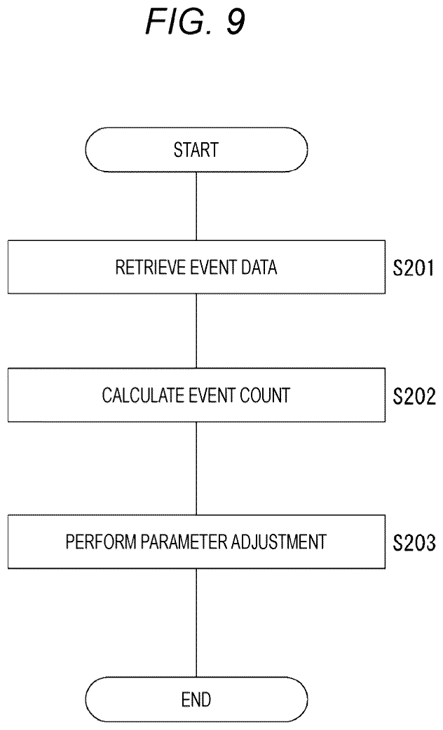

FIG. 9 illustrates an example. Note that, here, a description will be given assuming that the signal processing unit 15 performs the series of processing illustrated in FIG. 9. Furthermore, the signal processing unit 15 of the inspection system 1 periodically performs the series of processing illustrated in FIG. 9.

The signal processing unit 15 of the inspection system 1 retrieves the event data ED stored in the event data storage unit 21 in step S201.

Subsequently, the signal processing unit 15 calculates the event count in step S202. The processing in steps S201 and S202 is similar to the processing in steps S101 and S102 illustrated in FIG. 8. Therefore, various modifications of the processing in step S202, as described above, can be considered.

The camera drive unit 14 performs parameter adjustment in step S203. The parameter to be adjusted here is, for example, a detection threshold used for the event detection in the EVS 6. By raising the detection threshold, more significant changes in light quantity are required for event detection, making the event harder to detect.

Such adjustment is effective in a case where the defect notification is provided in the above-described step S104 despite no defect in the inspection object To.

Furthermore, the adjustment to raise the detection threshold is also effective in a case of narrowing the defect detection criteria. Specifically, in a case where market distribution is allowed without classifying small scratches as defects, raising the detection threshold is effective in reducing the likelihood of event occurrence.

On the other hand, in a case where a defect cannot be detected, conversely, lowering the detection threshold eliminates the need for significant changes in light quantity for event detection, making the event easier to detect.

Such adjustment is effective in a case where a defect in the inspection object To is undetected.

Furthermore, the adjustment to lower the detection threshold is also effective in a case of expanding the defect detection criteria. Specifically, in a case where it is desired to detect smaller defects, lowering the detection threshold is effective in increasing the likelihood of event occurrence.

There are other parameters subject to the parameter adjustment in step S203. For example, adjustment to change the intensity of the irradiation light La from the light source 5 included in the lighting device 3 of the inspection unit 2 may be performed. For example, the signal processing unit 15 outputs a command or information for reducing the intensity of the irradiation light La to the control unit 11 instead of raising the detection threshold. In response to this, the control unit 11 reduces the intensity of the irradiation light La by modifying a control parameter of the lighting device 3.

Furthermore, the signal processing unit 15 outputs a command or information for increasing the intensity of the irradiation light La to the control unit 11 instead of lowering the detection threshold. In response to this, the control unit 11 increases the intensity of the irradiation light La by modifying the control parameter of the lighting device 3.

Furthermore, in a case where a defect in the inspection object To is undetected or in a case where there are many false detections, the speed of the relative movement between the inspection object To and the inspection unit 2 may be reduced.

This enables more detailed inspection and allows for accurate defect detection.

As described above, performing the defect detection by calculating the event count contributes to reducing the processing load compared to a case of defect detection based on imaging to be described later.

Note that the processing in step S203 in FIG. 9 may be performed not only at predetermined time intervals but also in a case where the event count falls outside a predetermined range. For example, in a case where conditions such as ambient light vary in a manner that depends on seasonal and time-related factors, and each parameter is no longer appropriate, an increase or decrease in the event count may occur. By performing the processing in step S203 illustrated in FIG. 9 in a case where the event count falls outside the predetermined range, the frequency of parameter adjustment can be minimized, which contributes to reducing the computational load.

### <2-2. Second Detection Method>

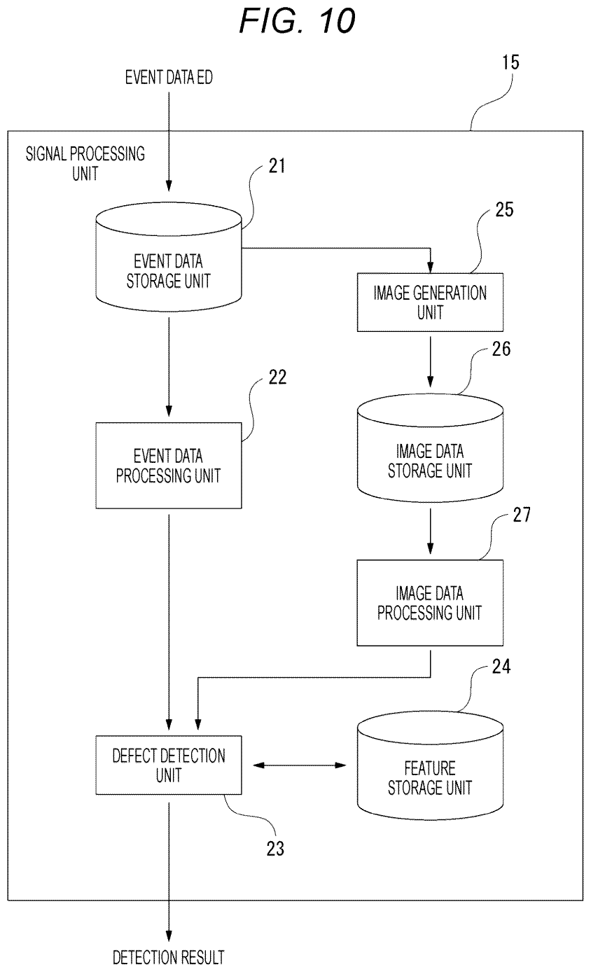

The second detection method is a method in which the EVS image described above is generated. FIG. 10 illustrates an example of the signal processing unit 15 capable of generating the EVS image.

Note that the components similar to those illustrated in FIG. 7 will be denoted by the same reference numerals, and description thereof will be omitted as appropriate.

The signal processing unit 15 includes an image generation unit 25 in addition to the event data storage unit 21, the event data processing unit 22, the defect detection unit 23, and the feature storage unit 24.

The image generation unit 25 retrieves the event data ED stored in the event data storage unit 21 and generates the EVS image.

The signal processing unit 15 includes an image data storage unit 26 that stores the EVS image generated by the image generation unit 25. Further included is an image data processing unit 27 that performs predetermined image processing on the EVS image.

The image data processing unit 27 retrieves the EVS image from the image data storage unit 26 and performs the predetermined image processing. The predetermined image processing is, for example, processing to convert. the EVS image into a display format that is easy for the user to view.

There are several possible examples of methods for generating the EVS image in the image generation unit 25.

A first example is an imaging method in which the event data ED occurred within a predetermined short period of time is mapped.

For example, with gray as the baseline, pixels where the ON event is detected are rendered in white and mapped, and pixels where the OFF event is detected are rendered in black and mapped. As a result, an EVS image where each event data ED is mapped to each pixel is generated.

A second example is a method using time delay integration (TDI). In this method, the occurrence timing of the event data ED is taken into consideration when mapping the event data ED occurred within a predetermined period. Specifically, even for pieces of event data ED generated within the same predetermined period but at different timings, the amount of movement by which the inspection object To moves relatively due to the time difference between the generation timings is taken into consideration.

In other words, it can be said that the EVS image is generated by superimposing a plurality of images where the event data ED is mapped on top of one another with the relative speed taken into consideration.

As a result, for example, an EVS image where, with gray as the baseline, pixels with more detected ON events are rendered in white, and pixels with more detected OFF events are rendered in black is generated.

Note that striped regions of interest (ROI) may be set in the EVS 6, and the event data ED detected in each striped area may be superimposed to ensure high-speed followability. That is, even in a state where the relative speed between the inspection object To and the inspection unit 2 is high and the event count for each image is low, making defect determination difficult, the accuracy of the determination result of the defect presence may be enhanced by appropriately superimposing the ROI regions in the plurality of images according to the relative speed.

By generating the EVS image as described above, it is possible to determine whether or not the determination result of the defect presence is correct by visually inspecting the EVS image.

Note that, the accuracy of the defect detection result may be improved not only by generating the EVS image by superimposing the mapping results of the event data ED obtained using the same EVS 6 at different timings, but also by superimposing the EVS images obtained using different EVSs 6 at different timings.

The processing to superimpose the EVS images is implemented by the image data processing unit 27, for example.

### 3. Modifications of First Embodiment

Some modifications of the first embodiment will be described below. However, each of the modifications can be applied, as needed, to other embodiments to be described later.

In the above-described example, the defect detection based on the bright-field imaging has been described as an example, but the defect detection based on the dark-field imaging may be performed.

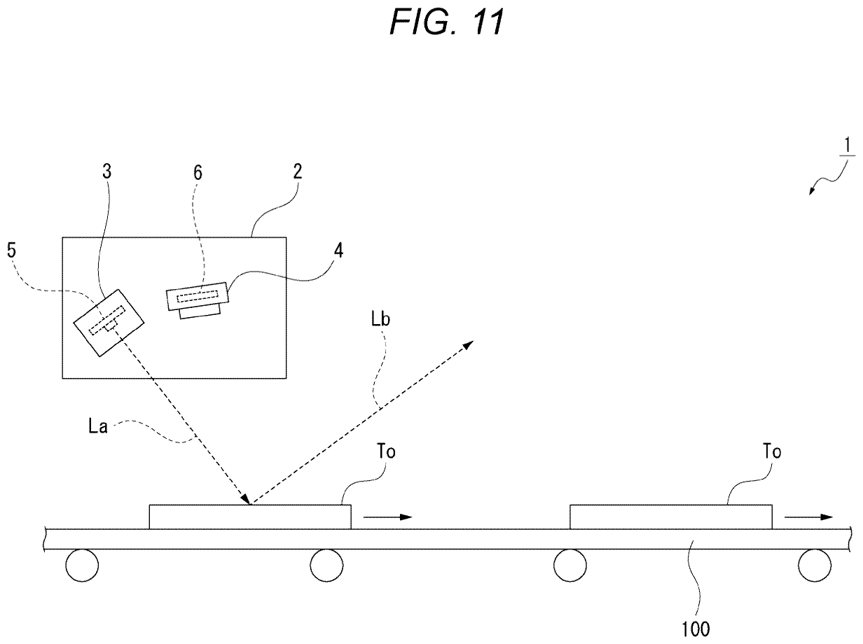

FIG. 11 illustrates an example of a positional relationship between the lighting device 3 and the camera device 4 in a case where the defect detection based on the dark-field imaging is performed.

As illustrated in the drawing, the camera device 4 is positioned to prevent the reflected light Lb corresponding to the irradiation light La emitted from the light source 5 of the lighting device 3 and reflected off the inspection object To from entering the EVS 6 in principle.

This reduces the quantity of light entering the EVS 6 compared to the bright-field imaging.

Then, in a case where a defect is present in the inspection object To, the reflected light Lb from the defect portion Pb in a direction different from usual enters the EVS 6.

As a result, in the pixel array unit 7 of the EVS 6, the ON event is detected in the imaging area where the defect portion Pb is imaged.

The defect detection based on the dark-field imaging is suitable, for example, in a case where the inspection object To includes metal that makes the irradiation light La less likely to undergo irregular reflection and more likely to undergo total reflection.

Note that, on an inspection object To including a material that causes the irradiation light La to undergo specular reflection on the flat portion Pa and irregular reflection on the defect portion Pb, the defect detection based on the bright-field imaging may be performed.

In a case where, like stained glass, the intensity of the reflected light Lb varies in a manner that depends on a location even on the flat portion Pa of the inspection object To, the wavelength (color), intensity, or irradiation pattern of the irradiation light La emitted from the light source 5 of the lighting device 3 may be adjusted according to the position on the inspection object To exposed to the irradiation light La.

This configuration can ensure that the intensity of the reflected light Lb on the flat portion Pa remains constant, which contributes to reducing the likelihood of falsely detecting the defect portion Pb.

### 4. Second Embodiment

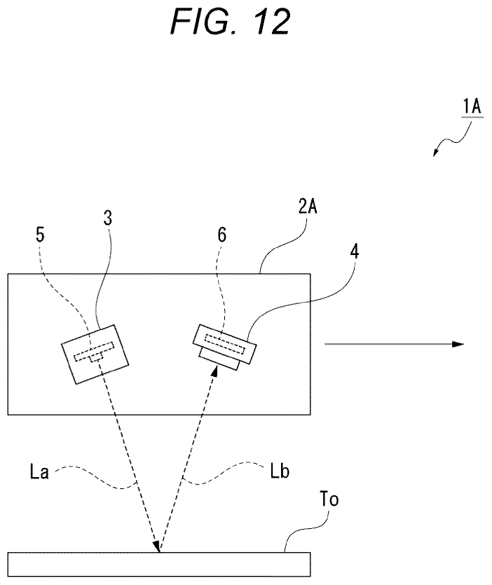

Unlike the first embodiment, an inspection system 1A according to the second embodiment has a configuration where an inspection unit 2A moves to detect a defect in the inspection object To in a stationary state (see FIG. 12).

In a case where the inspection object To is changed, a new inspection object To is placed at a predetermined position manually or by a conveying mechanism (not illustrated). The position of the inspection object To thus placed is fixed until the inspection is complete.

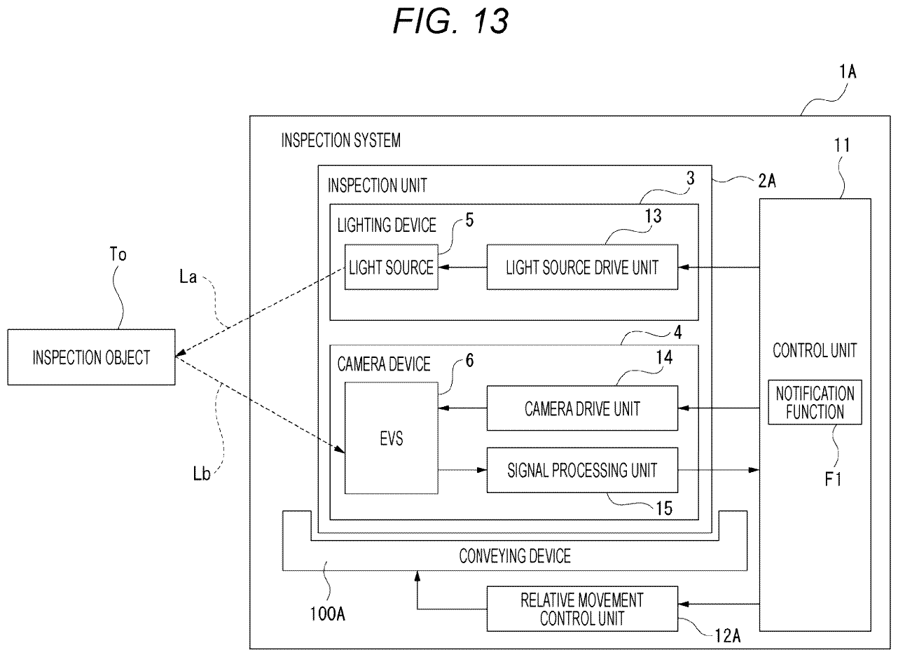

FIG. 13 illustrates an example configuration of the inspection system 1A. Note that the components similar to those illustrated in FIG. 3 will be denoted by the Same reference numerals, and description thereof will be omitted as appropriate.

The inspection system 1A includes a conveying device 100A responsible for conveyance, in addition to the inspection unit 2A, the control unit 11, and a relative movement control unit 12A.

The conveying device 100A includes a mechanism for moving the inspection unit 2A relative to the inspection object To.

Note that the conveying device 100A may be provided separately from the inspection system 1A, in a manner similar to the first embodiment. Alternatively, the inspection unit 2A may include the conveying device 100A.

The relative movement control unit 12A moves the inspection unit 2A by controlling the conveying device 100A. This configuration enables the relative movement between the inspection object To and the inspection unit 2A.

### 5. Third Embodiment

An inspection system 1B according to the third embodiment corresponds to a system based on a combination of the features of the inspection system 1 according to the first embodiment and the inspection system 1A according to the second embodiment.

Specifically, until a defect in the inspection object To is detected, the inspection object To is continuously moved in a manner similar to the inspection system 1 of the first embodiment, and upon detection of the defect, the inspection object To is stopped, and the inspection unit 2B is started to move, in a manner similar to the inspection system 1A of the second embodiment.

This configuration enables high-speed inspection while maintaining a high relative movement speed by moving the inspection object To at a relatively high speed until a defect is detected. Furthermore, after the defect is detected, more detailed inspection can be performed while moving the inspection unit 2B at a relatively low speed.

During the detailed inspection, for example, processing to determine whether or not the defect detection result is valid or processing to identify the shape, size, position, and the like of the detected defect is performed.

In the following description, the control to enable the relative movement by moving the inspection object To is referred to as “first movement control” , and the inspection performed under the first movement control is referred to as “simplified inspection”. Furthermore, the control to enable the relative movement by moving the inspection unit 2B will be referred to as “second movement control”, and the inspection performed under the second movement control will be referred to as “detailed inspection”. Note that the simplified inspection and the detailed inspection are defined for the sake of convenience of description and are not limited to such definitions, and the simplified inspection may be performed by moving the inspection unit 2B, and the detailed inspection may be performed by moving the inspection object To.

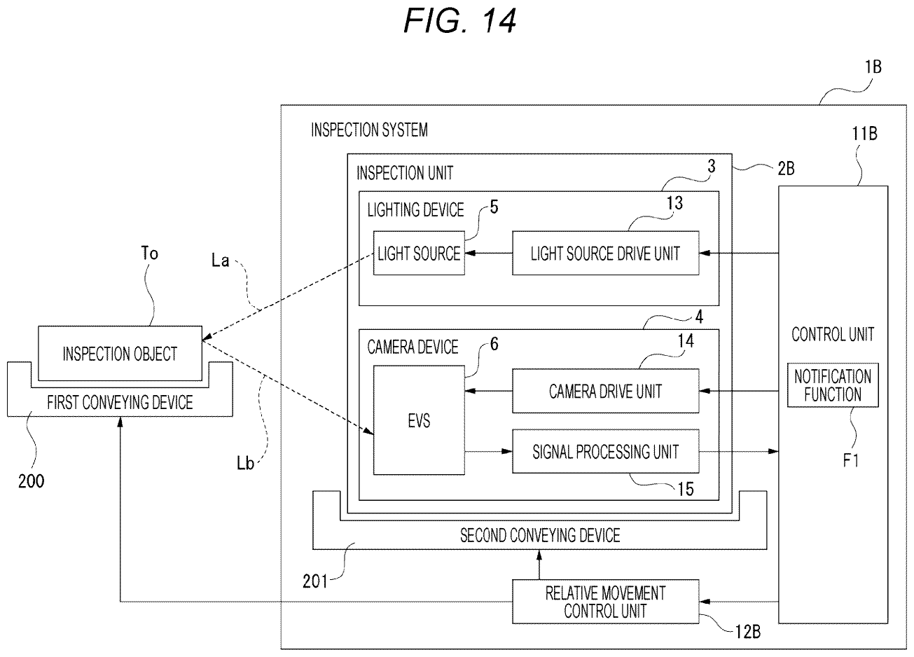

FIG. 14 illustrates an example configuration of the inspection system 1B. Note that the components similar to those described above will be denoted by the same reference numerals, and description thereof will be omitted as appropriate.

The inspection object To to be inspected by the inspection system 1B is placed on a first conveying device 200 such as a belt conveyor. The inspection object To is moved relative to the inspection unit 2B by the first conveying device 200 under the first movement. control during the simplified inspection.

The inspection system 1B includes the inspection unit 2B, a control unit 11B, a relative movement control unit 12B, and a second conveying device 201.

The second conveying device 201 is a device for moving the inspection unit 2B during the detailed inspection. As illustrated in FIG. 14, the second conveying device 201 may be included in the inspection system 1B, may be included in the inspection unit 2B, or may be provided separately from the inspection system 1B.

The control unit 11B determines whether to perform the simplified inspection or the detailed inspection on the basis of the defect detection result of the inspection object To, drives the first conveying device 200 under the first movement control via the relative movement control unit 12B during the simplified inspection, and drives the second conveying device 201 under the second movement control via the relative movement control unit 12B during the detailed inspection.

In accordance with the command from the control unit 11B, the relative movement control unit 12B drives the first conveying device 200 and stops the second conveying device 201 as the first movement control during the simplified inspection. Furthermore, in accordance with the command from the control unit. 11B, the relative movement control unit 12B drives the second conveying device 201 and stops the first conveying device 200 as the second movement control during the detailed inspection.

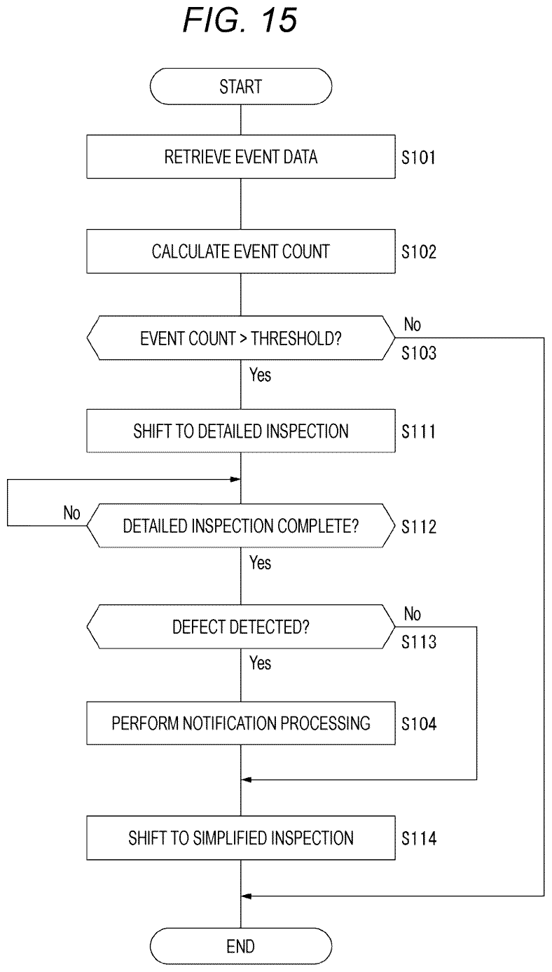

FIG. 15 illustrates a flow of processing that is performed by the inspection system 1B. Note that processing similar to that illustrated in FIG. 8 will be denoted by the same step number, and description thereof will be omitted as appropriate.

The series of processing illustrated in FIG. 15 is performed at regular time intervals unless a defect is detected in the inspection object To.

Furthermore, as a prerequisite for the processing illustrated in FIG. 15, the inspection system 1B is first in a state where the simplified inspection has been initiated. That is, during the processing in step S101 in FIG. 15, the first conveying device 200 is driven, and the second conveying device 201 remains in a stopped state, under the first movement control.

First, the signal processing unit 158 of the inspection system 1B retrieves the event data ED from the event data storage unit 21 in step S101, and calculates the event count in step S102.

In step S103, the signal processing unit 15B of the inspection system 1 performs determination of defect presence. The example illustrated in FIG. 15 corresponds to an example where the defect detection unit 23 determines whether or not the event count is greater than the threshold, in a manner similar to the example illustrated in FIG. 8.

Furthermore, in a case where the event count is determined to be equal to or less than the threshold in step S103, the inspection system 1B terminates the series of processing illustrated in FIG. 15 and waits until the next processing timing.

On the other hand, in a case where the event count is determined to be greater than the threshold, the control unit 11B of the inspection system 1B shifts to the detailed inspection in step S111. Specifically, the control unit 11B instructs the relative movement control unit 12B to perform the second movement control. In response to this, the relative movement control unit 12B causes the first conveying device 200 to stop the movement of the inspection object To and causes the second conveying device 201 to start the movement of the inspection unit 2B. This configuration enables the relative movement between the inspection object To and the inspection unit 2B through the movement of the inspection unit 2B.

Subsequently, the control unit 11B of the inspection system 1B determines in step S112 whether or not the detailed inspection is complete. As an example, the control unit 11B estimates the location of a possible defect portion Pb of the inspection object To where the event is detected during the simplified inspection.

Then, the control unit 11B determines whether or not the generation of the event data ED of the location of the possible defect portion Pb estimated through the imaging of the EVS 6 of the camera device 4 of the inspection unit 2B by the driving of the second conveying device 201 is complete.

The processing in step S112 is repeatedly performed until the control unit 11B of the inspection system 1B determines that the detailed inspection is complete.

In a case where it is determined in step S112 that the detailed inspection is complete, the control unit. 11B of the inspection system 1B determines whether or not a defect has been detected in step S113. This determination may be similar to the determination in step S103, or may be performed using a different threshold.

Then, in a case where it is determined that a defect is present in the inspection object To, the control unit 11B of the inspection system 1B performs the notification processing in step S104.

On the other hand, in a case where it is determined that no defect is present in the inspection object To, that is, in a case where the defect detected during the simplified inspection is determined to be a false detection, the control unit 11 of the inspection system 1B skips the processing in step S104 and proceeds to step S114.

In step S114, the control unit 11B of the inspection system 1B shifts to the simplified inspection. Specifically, the control unit 11B instructs the relative movement control unit 12B to perform the first movement. control. In response to this, the relative movement control unit 12B causes the second conveying device 201 to stop the movement of the inspection unit 2B and causes the first conveying device 200 to start the movement of the inspection object To. This configuration enables the relative movement between the inspection object To and the inspection unit 2B through the movement of the inspection object To.

After the end of the processing in step S114, the inspection system 1B terminates the series of processing illustrated in FIG. 15 and waits until the next processing cycle.

According to the present embodiment, it is possible to achieve both shorter inspection time and higher inspection accuracy.

Note that other examples of switching between the first movement control and the second movement control can be considered. For example, in a case where there are an area where defects are easily detected and an area where defects are rarely detected in the inspection object To, performing the detailed inspection on the former area under the second movement control and performing the simplified inspection on the latter area under the first movement control can be considered.

Furthermore, in a case where the manufacturing lot of the inspection object To is changed, performing the detailed inspection under the second movement control and switching between the first movement control and the second movement control as needed after the area where defects are easily detected is identified can be considered.

Furthermore, an aspect in which the first movement control and the second movement control are switched according to the state of ambient light can be considered.

### 6. Fourth Embodiment

An inspection system 1C according to the fourth embodiment detects a defect without relatively moving the inspection object To and an inspection unit 2C.

First, the inspection object To includes a transparent material. Then, a light source 5C included in a lighting device 30 of the inspection unit 20 is a blinking light source.

Furthermore, the EVS 6 of the camera device 4 of the inspection unit 2C performs event detection both when the light source 5C is turned on and when the light source 5C is turned off.

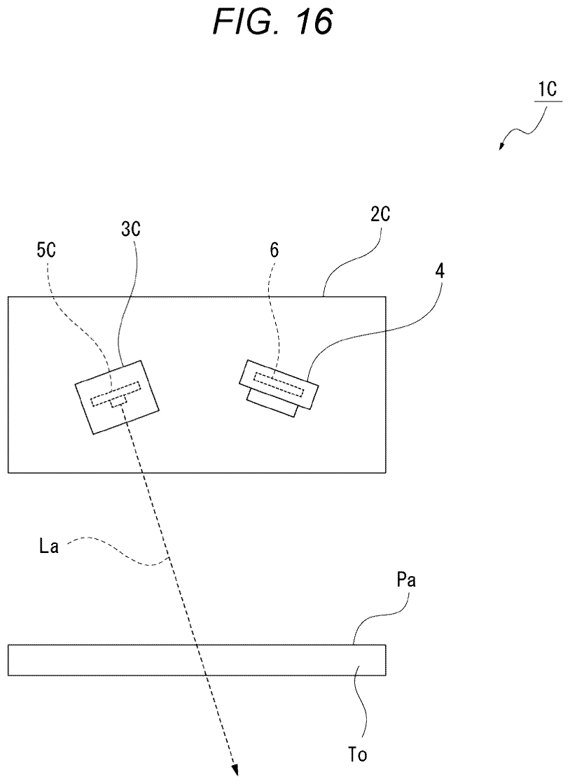

As illustrated in FIG. 16, the light source 5C irradiates the inspection object To with the irradiation light La in the turned-on state. It is assumed that the inspection object To includes a transparent material and has no defect portion Pb. In this case, the occurrence of the reflected light Lb from the irradiation light La is negligible as illustrated in FIG. 16. Therefore, almost no reflected light Lb enters the EVS 6 of the camera device 4 of the inspection unit 2C.

Furthermore, in the turned-off state, the light source 50 naturally does not emit the irradiation light La, and thus, there is no reflected light Lb.

Therefore, there is no significant difference in the intensity of the reflected light Lb incident on the EVS 6 between the turned-on state and the turned-off state of the light source 50, and no event is detected as a result.

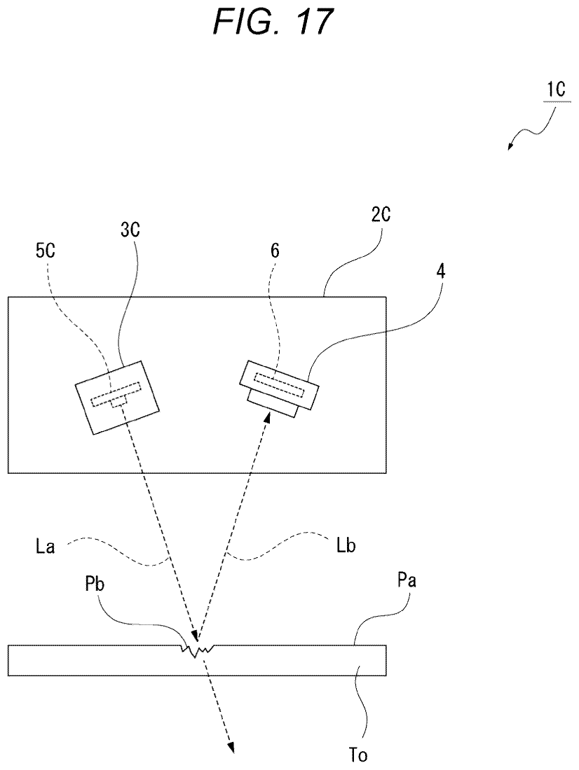

Here, FIG. 17 illustrates a case where the defect portion Pb is present in the inspection object To.

In the turned-on state of the light source 5C, when the defect portion Pb of the inspection object To is irradiated with the irradiation light La, at least part of the irradiation light La becomes the reflected light Lb and enters the EVS 6.

Then, in the turned-off state, the light source 5C naturally does not emit the irradiation light La, and thus, there is no reflected light Lb.

Therefore, there is a difference in the intensity of the reflected light Lb incident on the EVS 6 between the turned-on state and the turned-off state of the light source 5C, and an event is detected as a result.

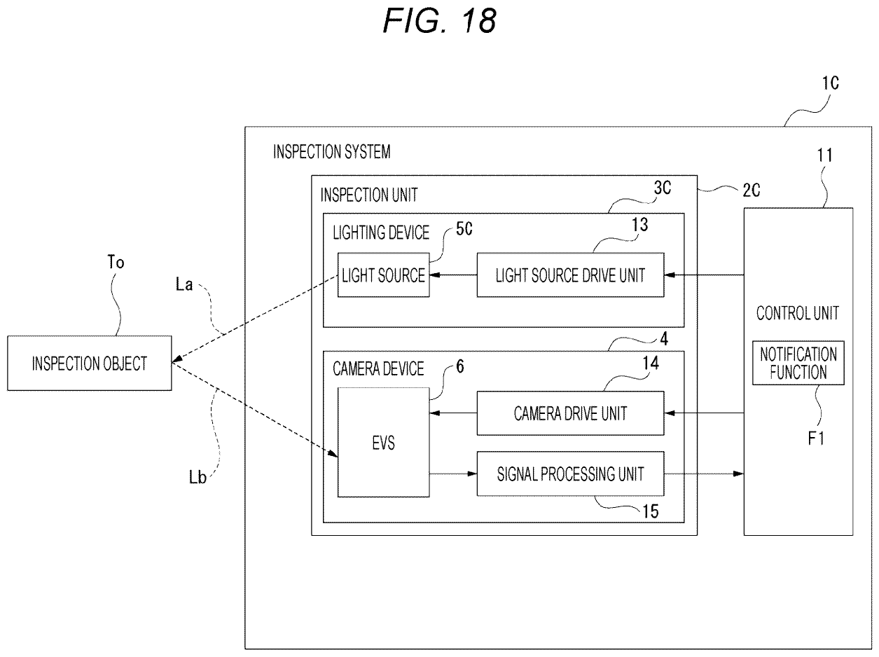

FIG. 18 illustrates an example configuration of the inspection system 1C according to the present embodiment.

The inspection system 1C includes the inspection unit 2C and the control unit 11. Then, the inspection system 1C does not include the relative movement control unit 12. This is because the defect detection is achieved by detecting a difference in the quantity of the reflected light Lb between the turned-on state and the turned-off state of the light source 5C as an event.

The lighting device 3C of the inspection unit 2C includes the light source 5C as a blinking light source.

The camera drive unit 14 of the camera device 4 determines the readout timing of the EVS 6 on the basis of the blinking cycle of the light source 5C of the lighting device 3C. Information regarding the blinking cycle of the light source 5C is provided to the camera device 4 via the control unit 11, for example.

A modification of the fourth embodiment will be described below.

In the fourth embodiment, the inspection object To and the inspection unit 2C may move relatively. In this case, the position of the inspection object To differs within the field of view of the EVS 6 due to a difference in the incident light reception timing between the turned-on state and the turned-off state, so that it is necessary to process the event data ED while considering the positional difference.

Furthermore, in a case where the entire inspection object To cannot fall within the field of view of the EVS 6, it is desirable that the inspection system 1C include the relative movement control unit 12. This configuration enables the inspection of the entire inspection object To.

Furthermore, the above-described example is based on the dark-field imaging in which the reflected light Lb does not essentially enter the EVS 6, but if the dark-field imaging is employed, the inspection object To may include an opaque material rather than a transparent material. Even with the opaque inspection object To, the reflected light Lb does not essentially enter the EVS 6 in the dark-field imaging, so that the ON event can be detected on the basis of the reflected light Lb generated at the defect portion Pb.

That is, the light source 5C serving as a blinking light source according to the fourth embodiment can be used as long as the reflected light Lb from the flat portion Pa does not enter the EVS 6 and only the reflected light Lb from the defect portion Pb enters the EVS 6.

Using the light source 5C serving as a blinking light source reduces power consumption compared to using an always-on light source.

### 7. Fifth Embodiment

An inspection system 1D according to the fifth embodiment includes a plurality of inspection units 2D.

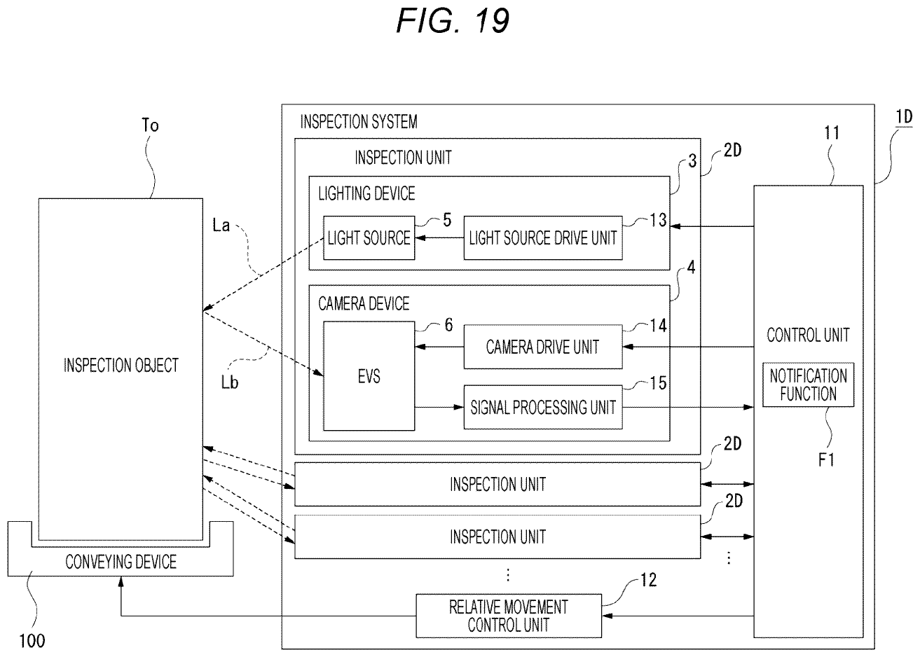

FIG. 19 illustrates an example configuration of the inspection system 1D. The inspection system 1D includes the plurality of inspection units 2D, the control unit 11, and the relative movement control unit 12. Each of the inspection units 2D is similar in configuration to, for example, the inspection unit 2 according to the first embodiment.

The relative movement control unit 12 can move the inspection object To by driving the conveying device 100. This configuration enables relative movement between each inspection unit 2D and the inspection object To.

Various arrangement examples of the plurality of inspection units 2D with respect to the inspection object To can be considered. Some examples will be described below.

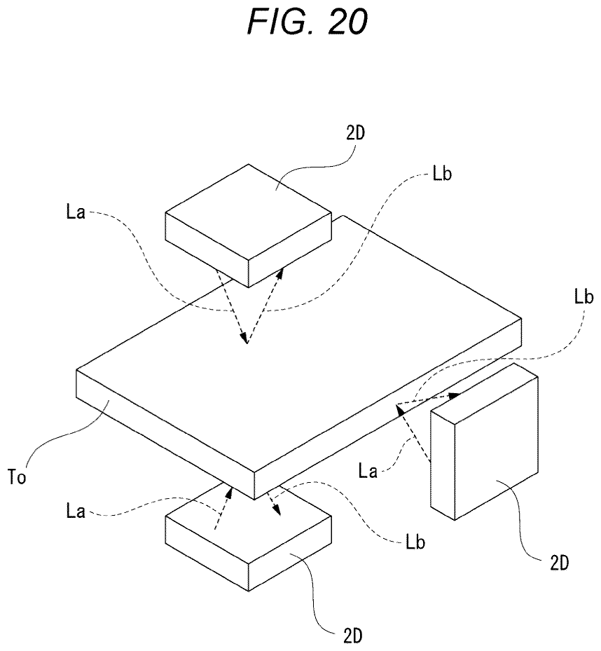

In a first arrangement example, as illustrated in FIG. 20, the inspection units 2D are arranged to face different surfaces of the inspection object To.

Specifically, one of the inspection units 2D is arranged above the top surface of the inspection object To to detect a defect on the top surface of the inspection object To. Furthermore, another inspection units 2D is arranged below the bottom surface of the inspection object To to detect a defect on the bottom surface of the inspection object To. Then, the other inspection units 2D is arranged below a side surface of the inspection object To to detect a defect on the side surface of the inspection object To.

This configuration enables simultaneous inspection of a plurality of side surfaces of the inspection object To, which contributes to reducing the inspection time.

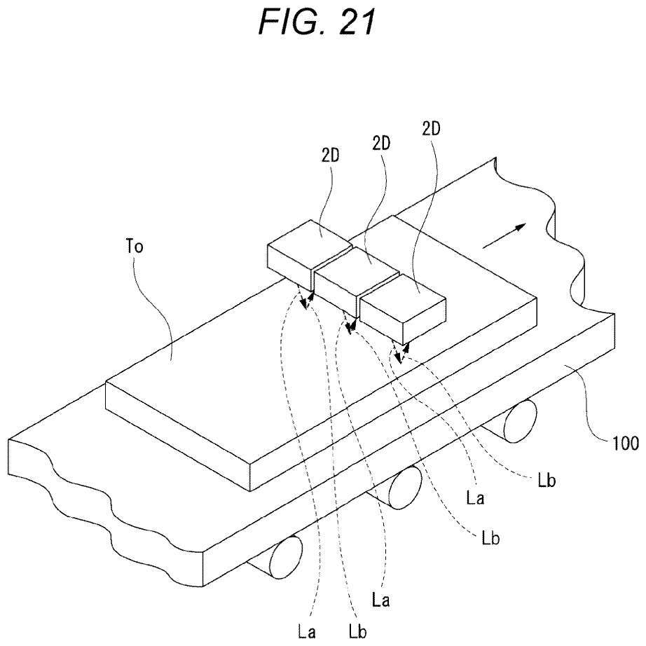

In a second arrangement example, as illustrated in FIG. 21, the inspection units 2D are arranged side by side in the direction orthogonal to the movement direction of the inspection object To, that is, the direction orthogonal to the relative movement direction.

This configuration can enlarge the inspection target area of the inspection object To. That is, the inspection area per unit time can be increased, which contributes to enhancing inspection efficiency.

Furthermore, in a case where the plurality of inspection units 2D is arranged within an area that can be inspected by a single inspection unit 2D, narrowing the field of view of the EVS 6 of each inspection unit 2D enables a higher-precision inspection.

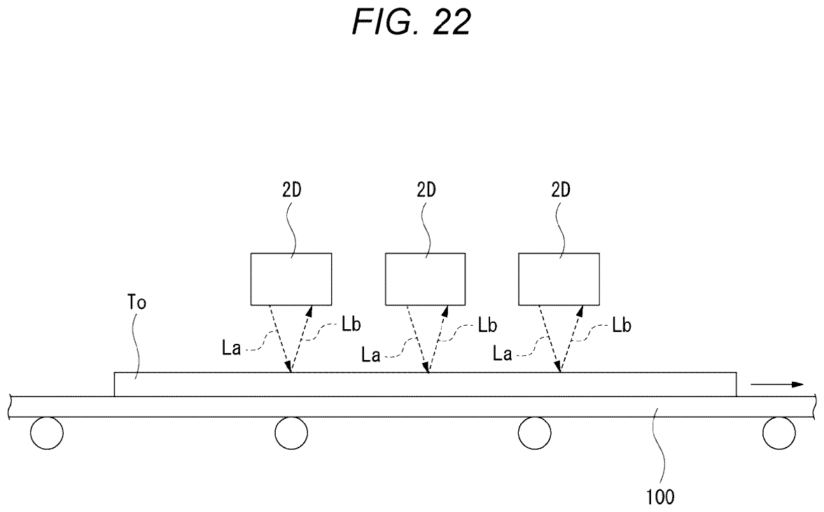

In a third arrangement example, as illustrated in FIG. 22, the inspection units 2D are arranged side by side along the movement direction of the inspection object To, that is, the relative movement direction.

In this arrangement example, each inspection unit 2D inspects the same area in the inspection object To with a time difference.

Therefore, it is possible to reduce variations in inspection results and improve defect detection accuracy.

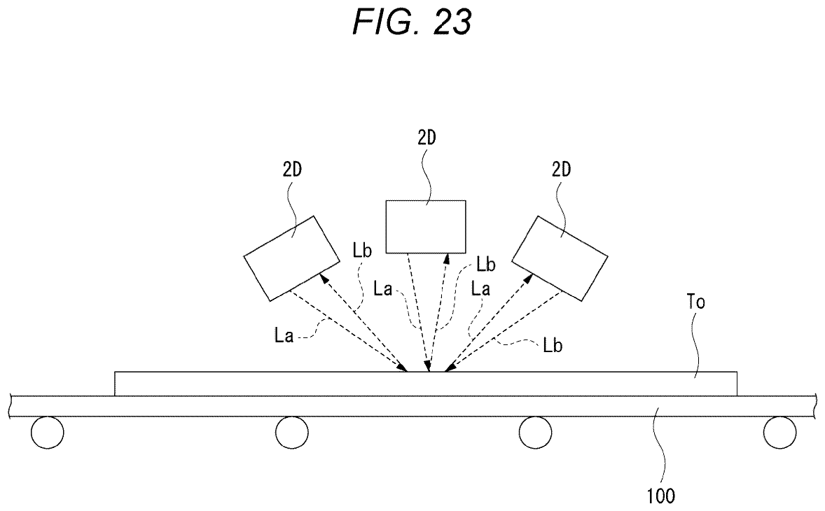

Note that, in the third arrangement example, the plurality of inspection units 2D may be configured to simultaneously inspect the same area in the inspection object To. For example, as illustrated in FIG. 23, one of the inspection units 2D is arranged to inspect the inspection object To from directly above, another inspection unit 2D is arranged to inspect the area extending from the front to a slightly rearward position in the direction of travel of the inspection object To, and the other inspection unit 2D is arranged to inspect the area extending from the rear to a slightly forward position in the direction of travel of the inspection object To.

The configuration where each inspection unit 2D has a differently oriented EVS 6 helps increase the likelihood that the defect portion Pb missed by one inspection unit 2D is detected by another inspection unit 2D.

Furthermore, in this case, some inspection units 2D may perform defect detection based on the bright-field imaging, and the remaining imaging methods may perform defect detection based on the dark-field imaging. This configuration enables the detection of the defect portion Pb in different manners, which helps increase the detection rate of the defect portion Pb.

A modification of the fifth embodiment will be described below.

In the fifth embodiment described above, the inspection system 1D includes the plurality of inspection units 2D, so that the inspection system 1D also includes a plurality of light sources 5. However, a single common light source 5 is provided for the plurality of inspection units 2D. In other words, a single inspection unit 2D may include a plurality of camera devices 4 and a single light source 5.

Furthermore, the inspection unit 2D may include only the camera device 4, and a single lighting device 3 may be provided separately from the inspection unit 2D.

### 8. Modifications

Although slightly mentioned in the above description, the inspection object To may include a curved surface as long as the inspection target area of the inspection object To can be considered approximately flat.

Specifically, for example, when the inspection object To is a windshield or a body of a vehicle, the inspection system 1 may be used to detect a scratch on the windshield or the body.

Alternatively, when the inspection object To is a curved display, the inspection system 1 may be used to detect a scratch on the curved display.

Note that the inspection object To may have a curved surface as long as the inspection target area of the inspection object To can be considered approximately flat; in other words, the inspection system 1 of the present technology can be applied to the defect detection of the inspection object To having a curved surface with low curvature by narrowing the field of view of the EVS 6 to the extent that the inspection target area can be considered approximately flat.

Furthermore, in a case where the inspection system 1 is applied to the inspection object To having a curved surface, and the positional relationship (distance) between the inspection unit 2 and the inspection object To varies during the relative movement between the inspection object To and the inspection unit 2, the inspection object To or the inspection unit 2 subjected to the relative movement control may be moved along the shape of the inspection object To.

In the above-described example, either the inspection object To or the inspection unit 2 is moved, but the relative movement may be achieved by moving both the inspection object To and the inspection unit 2.

This configuration can reduce the inspection time and achieve other improvements.

In the above-described example, the defect detection is performed on the basis of the event data ED output from the EVS 6, but the defect detection may be performed using a combination of sensors rather than the EVS 6.

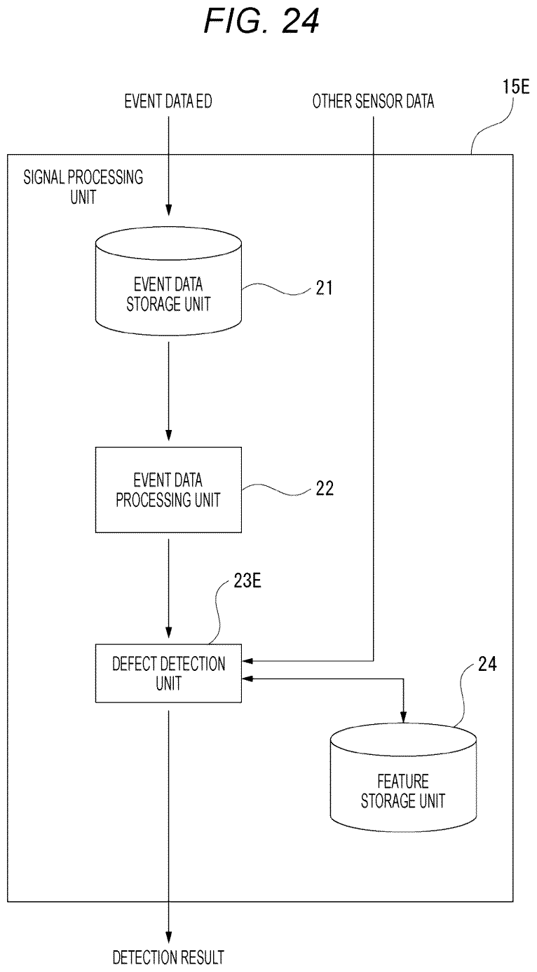

For example, as illustrated in FIG. 24, not only the event data ED but also other sensor data is input to a signal processing unit 15E of the camera device 4. Then, a defect detection unit 23E of the signal processing unit 15E detects the defect portion Pb using both the event data ED and the other sensor data.

Examples of the other sensors used in combination with the EVS 6 include an RGB sensor, a range sensor using a time of flight (ToF) method, and the like.

In a case where the RGB sensor is used in combination, for example, the defect detection unit 23E may detect the defect portion Pb using a combination of image data output from the RGB sensor and machine learning.

Furthermore, in a case where the range sensor is used in combination, the defect portion Pb that is a recess or a projection in the inspection object To is detected using distance data output from the range sensor. The quantity of the reflected light Lb from the inspection object To may vary in a manner that depends a blemish or similar factors, even when no defect portion Pb is present. However, using the range sensor in combination makes it possible to prevent the flat portion Pa with a blemish from being falsely detected as the defect portion Pb.

In the above-described example, the lighting device 3 and the camera device 4 of the inspection unit 2 are arranged on the same side of the inspection object To, but the present technology is not limited to such an arrangement.

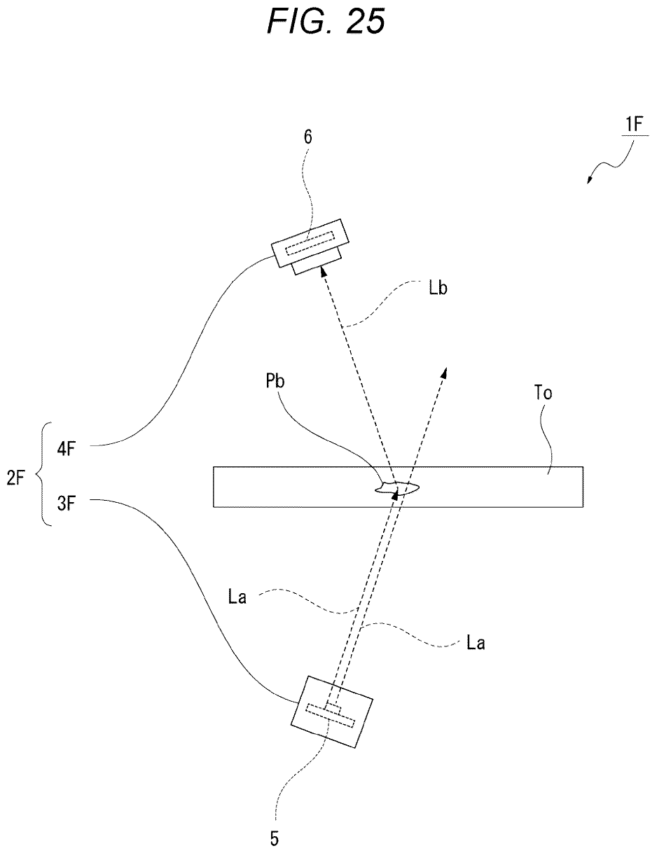

For example, as illustrated in FIG. 25, the inspection object To includes a transparent material, and a lighting device 3F and a camera device 4F of an inspection unit 2F of an inspection system 1F may be arranged on opposite sides of the inspection object To.

For example, detection of a defect such as a bubble formed inside the inspection object To using the inspection unit 2F is considered. The irradiation light La that has passed through a defect-free portion of the inspection object To does not enter the EVS 6, and no event is detected as a result. On the other hand, the irradiation light La that has passed through the defect portion Pb such as an internal bubble undergoes diffuse reflection at the defect portion Pb, and the reflected light Lb enters the EVS 6 as a result. Accordingly, an event is detected in the EVS 6.

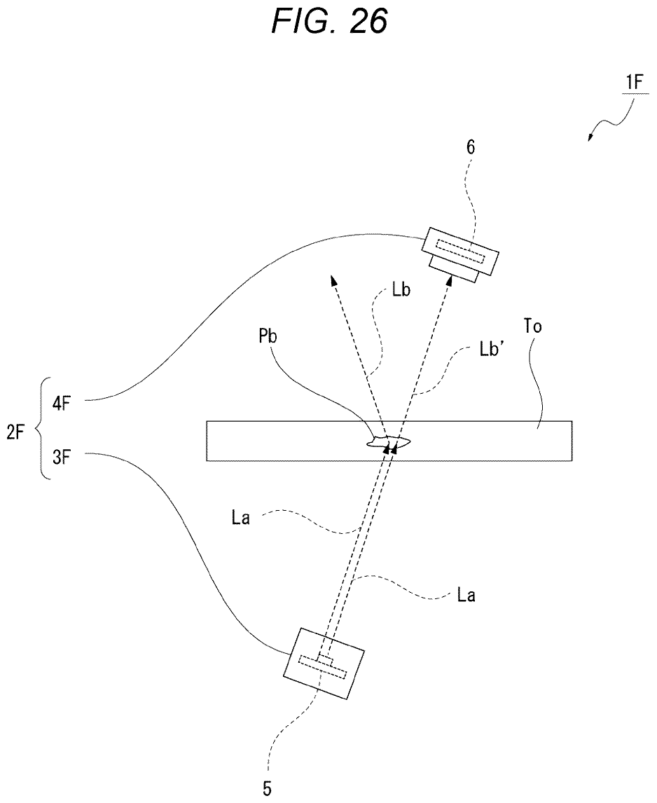

Note that the example illustrated in FIG. 25 is based on the dark-field imaging in which only the defect portion Pb appears bright, but an arrangement for the bright-field imaging may be employed as illustrated in FIG. 26. In this example, the irradiation light La that has passed through the defect-free portion of the inspection object To becomes transmitted light Lb′ and enters the EVS 6. On the other hand, the irradiation light La that has passed through the defect portion Pb such as an internal bubble undergoes diffuse reflection at the defect portion Pb, which reduces the intensity of the transmitted light Lb′ entering the EVS 6. Accordingly, the OFF event is detected in the EVS 6.

Note that, although the transmitted light Lb′ is not light reflected off the inspection object To, the transmitted light Lb′ corresponds to the reflected light Lb in a case where the bright-field imaging is employed in each example described above, and serves as light that triggers event detection.

FIG. 3 illustrates an example where the camera drive unit 14 and the signal processing unit 15 are included in the camera device 4, but the present technology can be applied to other configurations.

For example, an information processing device provided outside the camera device 4 may include a control unit having functions as the camera drive unit 14 and the signal processing unit 15. Furthermore, this control unit may be the control unit 11 illustrated in FIG. 3, or may be a control unit different from the control unit 11.

Examples of the information processing device provided outside the camera device 4 include various devices such as a stationary personal computer device, a dedicated terminal device, and a portable personal digital assistant (PDA) device, a smartphone device, and a tablet terminal.

### 9. Conclusion

As described in each of the examples described above, the inspection system 1 (1A, 1B, 1C, 1D, 1F) includes the event-based vision sensor (EVS 6) that captures an image of the inspection object To and detects changes in luminance for each pixel G as an event, and the control unit 11 (11B) that performs determination of defect presence in the inspection object To on the basis of the event data ED output from the EVS 6 according to the detected event.

Only pixels G exhibiting changes in luminance output the event data ED, enabling the EVS 6 to capture the appearance of a subject quickly and with low latency, compared to frame-based image sensors.

This configuration can reduce the time required for the determination of defect presence in the inspection object To. Furthermore, under the same inspection time condition, not only the inspection efficiency can be enhanced by inspecting a plurality of inspection objects To, but also the inspection accuracy can be enhanced by performing a plurality of inspections on a single inspection object To.

Furthermore, examples of defects include periodic and aperiodic defects.

As for the periodic defect, performing the one-cycle inspection on the inspection object To can produce effects similar to those produced by the inspection of the entire inspection object To. Then, the present configuration can reduce the time required to detect the periodic defect.

Furthermore, the aperiodic defect requires the inspection of the entire inspection object To, but the present configuration enables an improvement of inspection efficiency, allowing for more detailed inspections within the same time frame, thereby increasing the detection rate of the aperiodic defects. Furthermore, improving inspection efficiency allows for an increase in the number of inspection objects To that can be inspected per unit time.

As described with reference to FIG. 1 and the like, the inspection system 1 (1A, 1B, 1C, 1D, 1F) may include the light source 5 (5C) that irradiates the inspection object To with light.

Irradiating the inspection object To with light emitted from the light source 5 rather than ambient light enables the EVS 6 to receive a constant light quantity, regardless of whether it is the inspection based on the dark-field imaging or based on the bright-field imaging.

Therefore, it is possible to accurately detect that reflected light Lb different from reflected light Lb generated at the flat portion Pa having no defect is generated at the defect portion Pb.

As described with reference to FIG. 1 and the like, the relative positional relationship between the light source 5 (5C) and the EVS 6 of the inspection system 1 (1A, 1B, 1C, 1D, 1F) remains unchanged, and the control unit 11 (11B) may perform control to move the inspection object To relative to the light source 5 and the EVS 6.

This configuration makes the reflected light Lb from the flat portion Pa having no defect more constant, which contributes to reducing the likelihood of falsely detecting a nonexistent defect.

As described with reference to FIG. 5 and the like, in the inspection system 1 (1A, 1B, 1C, 1D, 1F), the direction of the relative movement between the light source 5 and the EVS 6, and the inspection object To may be aligned with the direction in which, in the pixel array unit 7 where the plurality of pixels G is arranged two-dimensionally, a plurality of pixels G that is read simultaneously during the unit readout is arranged.

This configuration causes a detected defect to be continuously detected on the same line (row or column) in the pixel array unit 7 as long as the defect remains within the field of view of the EVS 6, which contributes to accelerating the readout processing.

As described in the first embodiment with reference to FIGS. 1, 4, 5, and the like and the third embodiment with reference to FIGS. 14, 15, and the like, the control unit 11 (11B) of the inspection system 1 (1A, 1B, 1C, 1D, 1F) may control the relative movement between the light source 5 and the EVS 6, and the inspection object To by moving the inspection object To relative to the light source 5 (5C) and the EVS 6 whose positions are fixed.

This configuration enables defect detection for the entire inspection object To that does not fall within the field of view of EVS 6.

As described in the second embodiment with reference to FIGS. 12, 13, and the like and the third embodiment with reference to FIGS. 14, 15, and the like, the control unit 11 (11B) of the inspection system 1 (1A, 1B, 10, 1D, 1F) may control the relative movement between the light source 5 and the EVS 6, and the inspection object To by moving the light source 5 (5C) and the EVS 6 relative to the inspection object To whose position is fixed.

This configuration enables defect detection for inspection objects To that are difficult to move or hard to reposition.

Furthermore, moving the unit including the light source 5 and the EVS 6 relative to the inspection object To that can be moved but cannot be moved at high speed contributes to accelerating the inspection.

As described in the third embodiment with reference to FIGS. 14, 15, and the like, the control unit 11B of the inspection system 1 (1A, 1B, 1C, 1D, 1F) may be capable of performing the first movement control to move the inspection object To relative to the light source 5 (5C) and the EVS 6 whose positions are fixed and the second movement control to move the light source 5 and the EVS 6 relative to the inspection object To whose position is fixed. Moreover, the control unit 11B may perform the first movement control until a defect is found, and may perform the second movement control after the defect is found.

For example, the relative movement speed under the first movement control is set to a high level, and the relative movement speed under the second movement control is set to a low level.

This configuration enables high-speed defect detection, and in a case where a defect is detected, a detailed inspection can be performed on the defect. This makes it possible to obtain detailed information such as the shape and size of the defect while accelerating the inspection.

As described in the fourth embodiment with reference to each of FIGS. 16 to 18, the light source 5C of the inspection system 1 (1A, 1B, 1C, 1D, 1F) may be a flicker-free light source or a blinking light source, and the EVS 6 may be positioned at a location where an event is detected on the basis of the reflected light Lb emitted from the flicker-free light source or the blinking light source and reflected off the defect portion Pb.

For example, in the dark-field imaging using the blinking light source, the flat portion Pa having no defect makes the reflected light Lb generated by the lighting of the blinking light source less likely to enter the EVS 6, and the quantity of incident light is also reduced. Therefore, in the flat portion Pa, the difference in the quantity of incident light between the turned-on state and the turned-off state of the blinking light source is minimized, and no event is detected as a result. It is therefore possible to find a defect without relatively moving the unit including the light source 5C and the camera unit, and the inspection object To. Furthermore, the absence of the relative movement. between them improves defect detection accuracy.

As described in the modification with reference to FIGS. 25 and 26, the inspection object To of the inspection system 1 (1A, 1B, 1C, 1D, 1F) may include a transparent material, and the light source 5 (5C) may be positioned on the opposite side of the inspection object. To from where the EVS 6 is positioned.

In a case where the inspection object To is transparent, light emitted from the opposite side of the inspection object To enters the EVS 6. Then, the quantity of light incident on the EVS 6 varies in a manner that depends on whether or not a defect such as an internal bubble is present. It is therefore possible to perform determination of defect presence by detecting the variations as an event.

As described with reference to FIG. 1 and the like, the light source 5 (5C) of the inspection system 1 (1A, 1B, 1C, 1D, 1F) may be a flicker-free light source.

For example, combining the light sources 5 to prevent flickers eliminates, even in a case where the light source 5 that repeatedly turns on and off at predetermined intervals is used, the need to synchronize the readout timing of the EVS 6 with the lighting cycle of the light source 5, which contributes to simplifying the control. Furthermore, the EVS 6 can perform high-speed readout compared to the lighting cycle of the light source 5, which contributes to reducing inspection time.

As described in the fifth embodiment with reference to each of FIGS. 19 to 23 and the like, the inspection system 1 (1A, 1B, 1C, 1D, 1F) may include a plurality of EVSs 6.

This configuration can reduce inspection time and enhance inspection accuracy.

As described in the second arrangement example according to the fifth embodiment with reference to FIG. 21 and the like, the plurality of control units 11 (11B) of the inspection system 1 (1A, 1B, 1C, 1D, 1F) may perform control to move the inspection object To relative to the plurality of EVSs 6, and the plurality of EVSs 6 may be arranged along a direction orthogonal to the relative movement direction.

This configuration can increase the range where the inspection object To falls within the field of view of the EVSs 6. It is therefore possible to enhance inspection efficiency and reduce inspection time. Furthermore, even if the range where the inspection object To falls within the field of view is reduced by bringing the EVS 6 closer, the plurality of EVSs 6 thus provided eliminates the need to reduce the range that can be inspected simultaneously, so that it is possible to detect the shape of a defect and the like in more detail without increasing inspection time.

As described in the third arrangement example according to the fifth embodiment with reference to FIGS. 22, 23, and the like, the plurality of control units 11 (11B) of the inspection system 1 (1A, 1B, 1C, 1D, 1F) may perform control to move the inspection object To relative to the plurality of EVSs 6, and the EVSs 6 may be arranged along the relative movement direction.

This configuration enables a time-division inspection to be performed on the same area of the inspection object To using the plurality of EVSs 6. It is therefore possible to eliminate false detections and achieve other improvements, which contributes to enhancing inspection accuracy.

Furthermore, rather than performing a plurality of time-division inspections, the same area may be inspected simultaneously using the plurality of EVS 6. This configuration enables the imaging angle for the inspection target area to vary for each EVS 6, which contributes to preventing defects that cannot be detected at specific angles from being missed.

As described with reference to FIGS. 5, 6, and the like, in the inspection system 1 (1A, 1B, 1C, 1D, 1F), the direction in which, in the pixel array unit 7 where the plurality of pixels G is arranged two-dimensionally, a plurality of pixels G that is read simultaneously during unit readout is arranged may be aligned with the longitudinal direction of a defect that is likely to be detected in the inspection object To.

This configuration reduces the number of lines (rows or columns) where an event is detected, which contributes to accelerating the readout processing.

As described as the first detection method with reference to FIGS. 7, 8, 9, and the like, the control unit 11 (11B) of the inspection system 1 (1A, 1B, 1C, 1D, 1F) may perform determination of defect presence on the basis of the event detection frequency or event count in the EVS 6.

This configuration eliminates the need to perform imaging processing based on the event data ED output by the EVS 6, which contributes to reducing the processing load of the inspection system 1.

As described as the second detection method with reference to FIG. 10 and the like, the control unit 11 (11B) of the inspection system 1 (1A, 1B, 1C, 1D, 1F) may perform determination of defect presence on the basis of the image (EVS image) generated on the basis of the event detected in the EVS 6.

By performing imaging processing based on the event data ED, it is possible to obtain more detailed information regarding a detected defect.

As described in the third embodiment with reference to FIGS. 14, 15, and the like, in a case where the determination of defect presence leads to a conclusion that a defect is present, the control unit 11B of the inspection system 1 (1A, 1B, 1C, 1D, 1F) may identify at least one of the shape, size, or position of the detected defect.

This configuration enables the acquisition of more detailed defect information, which contributes to enhancing the effectiveness of the inspection performed by the inspection system 1.

The information processing device according to the present technology includes the control unit 11 (11B) that performs determination of defect presence in the inspection object To on the basis of the event data ED output from the EVS 6 that captures an image of the inspection object To and detects changes in luminance for each pixel G as an event.

The inspection method according to the present technology includes performing, by a computation device, determination of defect presence in the inspection object To on the basis of the event data ED output from the EVS 6 that captures an image of the inspection object To and detects changes in luminance for each pixel G as an event.

The program according to the present technology causes an information processing device to implement performing determination of defect presence in the inspection object To on the basis of the event data ED output from the EVS 6 that captures an image of the inspection object To and detects changes in luminance for each pixel G as an event.

Note that such a program can be recorded in advance in an HDD as a recording medium built in a device such as a computer device, a ROM in a microcomputer having a CPU, and the like.

Alternatively, the program may be temporarily or permanently stored (recorded) in a removable recording medium such as a flexible disk, a compact disc read only memory (CD-ROM), a magneto optical (MO) disk, a digital versatile disc (DVD), a Blu-ray disc (registered trademark), a magnetic disk, a semiconductor memory, or a memory card. Such a removable recording medium can be provided as so-called package software.

Furthermore, such a program may be installed from the removable recording medium into a personal computer and the like, or may be downloaded from a download site through a network such as a local area network (LAN) or the Internet.

The above-described various functions and effects can also be obtained through such an information processing device, inspection method, and program.

Note that the effects described in the present specification are merely examples and are not limited, and other effects may be provided.

Furthermore, the above-described examples may be combined in any way, and the above-described various functions and effects may be obtained even in a case where various combinations are used.

### 10. Present Technology

Note that the present technology can also employ the following configurations.

(1)

An inspection system including:
an event-based vision sensor that captures an image of an inspection object and detects changes in luminance for each pixel as an event; and
a control unit that performs determination of defect presence in the inspection object on the basis of event data that is output from the event-based vision sensor according to the event that has been detected.
   (2)

The inspection system according to the above (1), further including:
a light source that irradiates the inspection object with light.
   (3)

The inspection system according to the above (2), in which
a relative positional relationship between the light source and the event-based vision sensor remains unchanged, and
the control unit performs control to move the inspection object relative to the light source and the event-based vision sensor.
   (4)

The inspection system according to the above (3), in which
a direction of the relative movement is aligned with a direction in which, in a pixel array unit where the plurality of pixels is arranged two-dimensionally, a plurality of the pixels that is read simultaneously during unit readout is arranged.
   (5)

The inspection system according to the above (3) or (4), in which
the control unit controls the relative movement by moving the inspection object relative to the light source and the event-based vision sensor whose positions are fixed.
   (6)

The inspection system according to the above (3) or (4), in which
the control unit controls the relative movement by moving the light source and the event-based vision sensor relative to the inspection object whose position is fixed.
   (7)

The inspection system according to any one of the above (3) to (6), in which
the control unit is capable of performing:
first movement control to move the inspection object relative to the light source and the event-based vision sensor whose positions are fixed; and second movement control to move the light source and the event-based vision sensor relative to the inspection object whose position is fixed.
   (8)

The inspection system according to the above (7), in which
the control unit performs the first movement control until a defect is found, and performs the second movement control after the defect is found.
   (9)

The inspection system according to any one of the above (2) to (8), in which
the light source includes a flicker-free light source or a blinking light source, and
the event-based vision sensor is positioned at a location where the event is detected on the basis of reflected light emitted from the flicker-free light source or the blinking light source and reflected off the defect.
   (10)

The inspection system according to any one of the above (2) to (9), in which
the inspection object includes a transparent material, and
the light source is positioned on an opposite side of the inspection object from where the event-based vision sensor is positioned.
   (11)

The inspection system according to any one of the above (2) to (10), in which
the light source includes a flicker-free light source.
   (12)

The inspection system according to any one of the above (1) to (11), further including:
a plurality of the event-based vision sensors.
   (13)

The inspection system according to the above (12), in which
the control unit performs control to move the inspection object relative to the plurality of event-based vision sensors, and
the plurality of event-based vision sensors is arranged along a direction orthogonal to a direction of the relative movement.
   (14)

The inspection system according to the above (12), in which
the control unit performs control to move the inspection object relative to the plurality of event-based vision sensors, and
the plurality of event-based vision sensors is arranged along a direction of the relative movement.
   (15)

The inspection system according to any one of the above (1) to (3), in which
a direction in which, in a pixel array unit where the plurality of pixels is arranged two-dimensionally, a plurality of the pixels that is read simultaneously during unit readout is arranged is aligned with a longitudinal direction of a defect that is likely to be detected in the inspection object.
   (16)

The inspection system according to any one of the above (1) to (15), in which
the control unit performs the determination of defect presence on the basis of detection frequency or an event count of the event in the event-based vision sensor.
   (17)

The inspection system according to any one of the above (1) to (15), in which
the control unit performs the determination of defect presence on the basis of an image that is generated on the basis of the event detected by the event-based vision sensor.
   (18)

The inspection system according to any one of the above (1) to (17), in which
in a case where the determination of defect presence leads to a conclusion that a defect is present, the control unit identifies at least one of a shape, size, or position of the defect that has been detected.
   (19)

An information processing device including:
a control unit that performs determination of defect presence in an inspection object on the basis of event data output from an event-based vision sensor that captures an image of the inspection object and detects changes in luminance for each pixel as an event.
   (20)

An inspection method including:
performing, by a computation device, determination of defect presence in an inspection object on the basis of event data output from an event-based vision sensor that captures an image of the inspection object and detects changes in luminance for each pixel as an event.
   (21)

A program causing an information processing device to implement performing determination of defect presence in an inspection object on the basis of event data output from an event-based vision sensor that captures an image of the inspection object and detects changes in luminance for each pixel as an event.

### REFERENCE SIGNS LIST

1, 1A, 1B, 1C, 1D Inspection system
5, 5C Light source
6 Event-based vision sensor (EVS)
7 Pixel array unit
To Inspection object
G Pixel
ED Event data

1. An inspection system comprising:
an event-based vision sensor that captures an image of an inspection object and detects changes in luminance for each pixel as an event; and
a control unit that performs determination of defect presence in the inspection object on a basis of event data that is output from the event-based vision sensor according to the event that has been detected.

2. The inspection system according to claim 1, further comprising:
a light source that irradiates the inspection object with light.

3. The inspection system according to claim 2, wherein
a relative positional relationship between the light source and the event-based vision sensor remains unchanged, and
the control unit performs control to move the inspection object relative to the light source and the event-based vision sensor.

4. The inspection system according to claim 3, wherein
a direction of the relative movement is aligned with a direction in which, in a pixel array unit where the plurality of pixels is arranged two-dimensionally, a plurality of the pixels that is read simultaneously during unit readout is arranged.

5. The inspection system according to claim 3, wherein
the control unit controls the relative movement by moving the inspection object relative to the light source and the event-based vision sensor whose positions are fixed.

6. The inspection system according to claim 3, wherein
the control unit controls the relative movement by moving the light source and the event-based vision sensor relative to the inspection object whose position is fixed.

7. The inspection system according to claim 3, wherein
the control unit is capable of performing:
first movement control to move the inspection object relative to the light source and the event-based vision sensor whose positions are fixed; and second movement control to move the light source and the event-based vision sensor relative to the inspection object whose position is fixed.

8. The inspection system according to claim 7, wherein
the control unit performs the first movement control until a defect is found, and performs the second movement control after the defect is found.

9. The inspection system according to claim 2, wherein
the light source includes a flicker-free light source or a blinking light source, and
the event-based vision sensor is positioned at a location where the event is detected on a basis of reflected light emitted from the flicker-free light source or the blinking light source and reflected off the defect.

10. The inspection system according to claim 2, wherein
the inspection object includes a transparent material, and
the light source is positioned on an opposite side of the inspection object from where the event-based vision sensor is positioned.

11. The inspection system according to claim 1, further comprising:
a plurality of the event-based vision sensors.

12. The inspection system according to claim 11, wherein
the control unit performs control to move the inspection object relative to the plurality of event-based vision sensors, and
the plurality of event-based vision sensors is arranged along a direction orthogonal to a direction of the relative movement.

13. The inspection system according to claim 11, wherein
the control unit performs control to move the inspection object relative to the plurality of event-based vision sensors, and
the plurality of event-based vision sensors is arranged along a direction of the relative movement.

14. The inspection system according to claim 1, wherein
a direction in which, in a pixel array unit where the plurality of pixels is arranged two-dimensionally, a plurality of the pixels that is read simultaneously during unit readout is arranged is aligned with a longitudinal direction of a defect that is likely to be detected in the inspection object.

15. The inspection system according to claim 1, wherein
the control unit performs the determination of defect presence on a basis of detection frequency or an event count of the event in the event-based vision sensor.

16. The inspection system according to claim 1, wherein
the control unit performs the determination of defect presence on a basis of an image that is generated on a basis of the event detected by the event-based vision sensor.

17. The inspection system according to claim 1, wherein
in a case where the determination of defect presence leads to a conclusion that a defect is present, the control unit identifies at least one of a shape, size, or position of the defect that has been detected.

18. An information processing device comprising:
a control unit that performs determination of defect presence in an inspection object on a basis of event data output from an event-based vision sensor that captures an image of the inspection object and detects changes in luminance for each pixel as an event.

19. An inspection method comprising:
performing, by a computation device, determination of defect presence in an inspection object on a basis of event data output from an event-based vision sensor that captures an image of the inspection object and detects changes in luminance for each pixel as an event.

20. A program causing an information processing device to implement:
performing determination of defect presence in an inspection object on a basis of event data output from an event-based vision sensor that captures an image of the inspection object and detects changes in luminance for each pixel as an event.
